(19) United States
(12) Patent Application Publication
(10) Pub. No.: US 2017/0140118 A1
(43) Pub. Date: May 18, 2017

(54) METHOD AND SYSTEM FOR GENERATING AND VISUALLY DISPLAYING INTER-RELATIVITY BETWEEN TOPICS OF A HEALTHCARE TREATMENT TAXONOMY

(71) Applicant: UCB BIOPHARMA SPRL, Brussels (BE)

(72) Inventors: Nassim HADDAD, Brussels (BE); Arnaud LIEUTENANT, Brussels (BE); Thomas FILAIRE, Brussels (BE)

(21) Appl. No.: 14/945,070

(22) Filed: Nov. 18, 2015

(51) Int. Cl. G06F 19/00; G06F 3/0486; G06F 3/0484

(52) U.S. Cl. CPC G06F 19/3406; G06F 3/04847; G06F 3/0486; G06F 19/3418

(57) ABSTRACT

A computerized method for displaying categorized healthcare textual data after a taxonomy has been applied to a data set is provided. The method includes generating a visual network generator graphical user interface configured to display a visual network comprised of a plurality of nodes and links, each of the nodes corresponding to a healthcare treatment topic, each of the links connecting two of the nodes; receiving a nodes input delimiting a number of the nodes to be displayed in the visual network; receiving at least one links input delimiting the links to be displayed in the visual network, the at least one links input including a first link input delimiting the links based on a modifiable metric representing a mixture of a first metric and a second metric, the first metric indicating a strength of potential links of each of the topics represented by one of the delimited nodes in the data set with each of the topics represented by the other delimited nodes of the data set, the second metric indicating a strength of each of the potential links of the delimited nodes in comparison to other potential links of the two respective delimited nodes each of the potential links is connecting; and generating, in response to the nodes input and the at least one links input, the delimited nodes and the delimited links in the visual network on the visual network generator graphical user interface to illustrate correlations between the healthcare treatment topics of different categories.

The present disclosure relates generally to data mining and analysis and more specifically to a method and system for generating and displaying links between topics in a healthcare treatment data set.

The Detailed Description and drawings of the present application are also filed in a copending application identified by attorney docket number 505.1001, entitled METHOD AND SYSTEM FOR GENERATING AND DISPLAYING TOPICS IN RAW UNCATEGORIZED DATA AND FOR CATEGORIZING SUCH DATA, filed on the same date as the present application, and a copending application identified by attorney docket number 505.1005, entitled METHOD AND SYSTEM FOR GENERATING AND DISPLAYING STRUCTURED TOPICS OF A HEALTHCARE TREATMENT TAXONOMY IN DIFFERENT FORMATS, filed on the same date as the present application.

### BACKGROUND

Conventionally, taxonomies in the health care field are created by technical data analysis experts, and the inputs of subject matter experts are very limited.

### SUMMARY OF THE INVENTION

A computerized method for displaying categorized healthcare textual data after a taxonomy has been applied to a data set is provided. The method includes generating a visual network generator graphical user interface configured to display a visual network comprised of a plurality of nodes and links, each of the nodes corresponding to a healthcare treatment topic, each of the links connecting two of the nodes; receiving a nodes input delimiting a number of the nodes to be displayed in the visual network; receiving at least one links input delimiting the links to be displayed in the visual network, the at least one links input including a first link input delimiting the links based on a modifiable metric representing a mixture of a first metric and a second metric, the first metric indicating a strength of potential links of each of the topics represented by one of the delimited nodes in the data set with each of the topics represented by the other delimited nodes of the data set, the second metric indicating a strength of each of the potential links of the delimited nodes in comparison to other potential links of the two respective delimited nodes each of the potential links is connecting; and generating, in response to the nodes input and the at least one links input, the delimited nodes and the delimited links in the visual network on the visual network generator graphical user interface to illustrate correlations between the healthcare treatment topics of different categories.

A computer program product implementing the method is also provided.

An electronic system including a processor and a memory for displaying categorized healthcare textual data after a taxonomy has been applied to a data set is also provided. The electronic system includes a generating module configured for generating a visual network generator graphical user interface configured to display a visual network comprised of a plurality of nodes and links, each of the nodes corresponding to a healthcare treatment topic, each of the links connecting two of the nodes; a first receiving module configured for receiving a nodes input delimiting a number of the nodes to be displayed in the visual network; and a second receiving module configured for receiving at least one links input delimiting the links to be displayed in the visual network, the at least one links input including a first link input delimiting the links based on a modifiable metric representing a mixture of a first metric and a second metric, the first metric indicating a strength of potential links of each of the topics represented by one of the delimited nodes in the data set with each of the topics represented by the other delimited nodes of the data set, the second metric indicating a strength of each of the potential links of the delimited nodes in comparison to other potential links of the two respective delimited nodes each of the potential links is connecting, the generating module configured for generating, by the server, in response to the nodes input and the at least one links input, the delimited nodes and the delimited links in the visual network on the visual network generator graphical user interface to illustrate correlations between the healthcare treatment topics of different categories

### BRIEF DESCRIPTION OF THE DRAWINGS

The present invention is described below by reference to the following drawings, in which:

FIG. 1 shows a computer displaying illustrating a main GUI displaying six different applications according to an exemplary embodiment of the invention;

FIGS. 2 to 4 illustrate views of a first application GUI generated by a first application shown in FIG. 1 according to an embodiment of the present invention;

FIGS. 5 to 17 illustrate views of a second application GUI generated by a second application shown in FIG. 1 according to an embodiment of the present invention;

FIG. 18 shows a flow chart of a method of searching and organizing a healthcare textual data set in accordance with the first application GUI described with respect to FIGS. 2 to 4 and the second application GUI 58 described with respect to FIGS. 5 to 17;

FIGS. 19 to 28b illustrate views of a third application GUI generated by a third application shown in FIG. 1 according to an exemplary embodiment of the present invention;

FIG. 29a shows a flowchart for a method of determining the links between nodes in accordance with the third application GUI described with respect to FIGS. 19 to 28b;

FIG. 29b shows an electronic system configured for displaying and modifying the third application GUI in accordance with the description of FIGS. 19 to 29a;

FIGS. 30 to 35 illustrate views of a fourth application GUI generated by a fourth application shown in FIG. 1 according to an exemplary embodiment of the present invention;

FIGS. 36 and 37 illustrate views of a fifth application GUI generated by a fifth application shown in FIG. 1 according to an exemplary embodiment of the present invention; and

FIGS. 38 to 44 illustrate views of a sixth application GUI generated by a sixth application shown in FIG. 1 according to an exemplary embodiment of the present invention.

### DETAILED DESCRIPTION

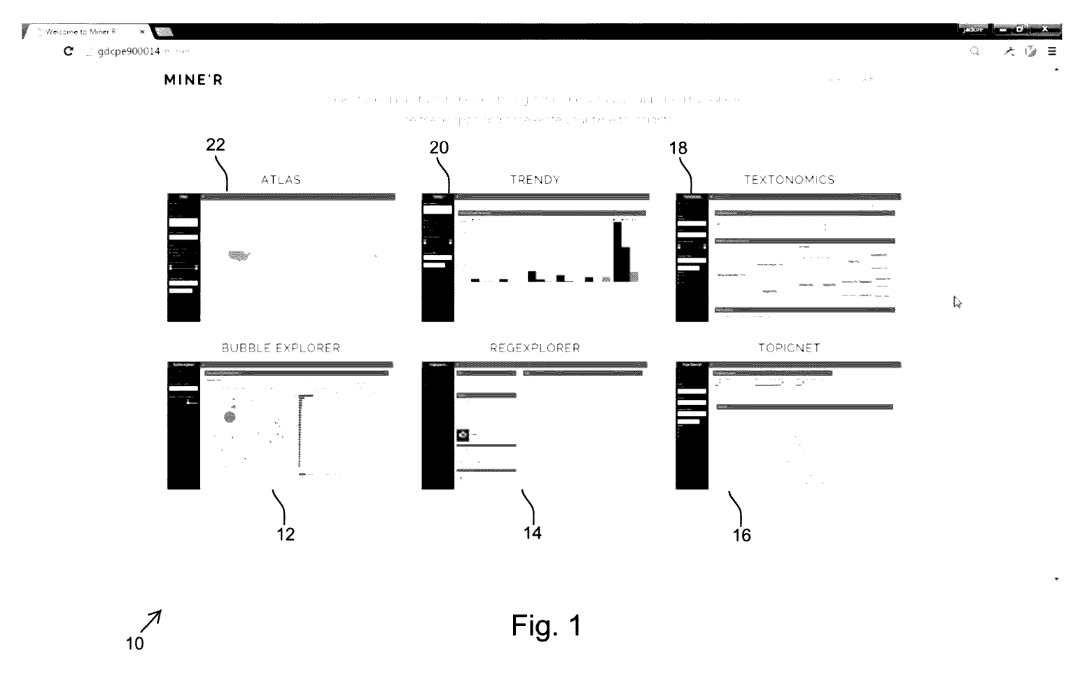

FIG. 1 shows a main GUI 10 displaying six different applications according to an embodiment of the invention. The applications includes a first application 12 for displaying a first application GUI, a second application 14 for displaying a second application GUI, a third application 16 for displaying a third application GUI, a fourth application 18 for displaying a fourth application GUI, a fifth application 20 for displaying a fifth application GUI and a sixth application 22 for displaying a sixth application GUI. A server including a processor and a memory displays these GUIs and modifies the GUIs as described below in response to user inputs to carry out methods in accordance with the embodiments described with respect to FIGS. 1 to 44. Each application may be individually selected via a mouse click or touch screen selection to display the corresponding application GUI on the computer display. The applications relate to one or more textual data set that includes a plurality of text documents. The text documents may include data entries in the form unstructured text from emails, webforms and transcribed phone calls, with each data entry being considered a different document. More specifically, in the exemplary embodiment and the alternatives thereof described herein, the textual data set is obtained from a medical information system, which is a database which captures queries and feedback from patients and health care professionals (e.g., doctors, nurses and pharmacists), as well as related answers, from forty countries in a standardized way. In other embodiments, the textual data set may alternatively and additionally comprise a compilation of social media posts.

The first application GUI is generated by selection of the first application 12 to display topics in raw uncategorized data set related to a selected subject for a selected geographic region. As used herein, raw uncategorized data is defined as sentences written in natural language, i.e., meant to be read by humans, as opposed to structured data, meant to be queried or processed by a computer. The first application thus gives an unsupervised view (i.e., prior to categorization via expert analysis) of the data set, allowing a user without expertise in the field of data mining and analysis to analyze the data set without a priori knowledge of the data set.

The second application GUI is generated by selection of the second application 14 to display a word searchable taxonomy that is modifiable by a user. The second application GUI is configured for searching for keywords that may be saved to modify the taxonomy.

The third application GUI is generated by selection of the third application 16 to display a visual network of the content of the data set, which allows understanding of links between different topics inside the data after the has been sorted by taxonomy using the second application 14 into categories. The third application GUI displays nodes and links between the nodes. Each node represents a specific categorized topic in the taxonomy and the nodes are colored according to their category level. The linking of the nodes is dictated by the frequency of their appearance together within a document of the text and different colored nodes can be linked.

The fourth application GUI is generated by selection of the fourth application 18 to display high level topics of the data sorted by percentages or visually displaying the taxonomy structure. High level topics can be selected to break down the high level topic into subtopics and to illustrate the frequency of the topics in the data over time.

The fifth application GUI is generated by selection of the fifth application 20 to display the number of documents in the textual data for a selected topic per geographical region.

The sixth application GUI is generated by selection of the sixth application 22 to display topics that are trending over time, illustrating increases and decreases of prevalence of topics and thus the importance thereof.

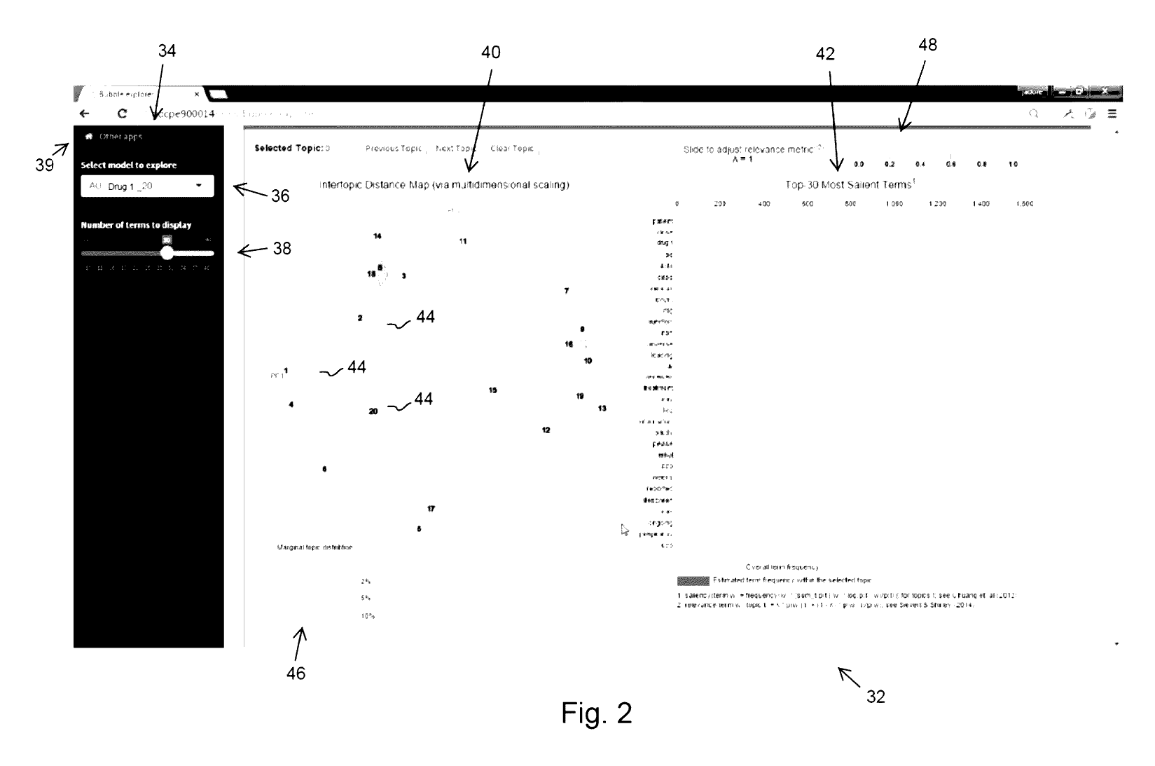

FIG. 2 illustrates a first view of a first application GUI 32 generated by first application 12 according to the exemplary embodiment of the present invention. The first application GUI 32—i.e., a topic modeler GUI—includes a panel 34 at a left-side region thereof allowing a user to select a textual model defining a corpus of documents to explore and a number of terms to display. In the embodiment shown in FIG. 2, the textual model is selected from a list of options displayed in a model delimiter in the form of a drop-down menu 36. The drop-down menu 36 lists a plurality of models, each defined by a healthcare treatment product of interest, a geographic region and a number of topics. For the example shown in FIG. 2, the selection made in drop-down menu 36 relates to the Drug 1, the geographic region of Australia, and twenty topics. The selected textual model includes textual data in the form of documents including statement from patients and health care professionals in regards to Drug 1 in the geographic region, Australia.

Panel 34 further includes a topic size delimiter 38 including a button slidable along a scale to select a number of terms to display in GUI 32. For the example shown in FIG. 2, the selection made via topic size delimiter 38 is thirty terms. A user may exit GUI 32 and return to main GUI 10 to interact with the other applications 12, 16, 18, 20, 22 by selecting a home icon 39 shown in an upper left hand portion of panel 34.

To the right of panel 34, GUI 32 includes an intertopic distance map 40 and a terms graph 42. Intertopic distance map 40 displays a plurality of icons 44, which are each in the form of a bubble representing a latent topic in the textual model selected via drop-down menu 36. The topics represented by intertopic distance map 40 have not been defined by an expert or any other human user, but merely represent results from a predefined topic model algorithm. The topic model algorithm consists of a representation of text as three layers: documents, topics and words. A document is made of topics, and topics are made of words. In one preferred embodiment, the topic model algorithm mathematically links each layer to the next layer via a non-linear model in the form of a Latent Dirichlet Allocation (LDA) implementation. The LDA model algorithm is fit to the raw uncategorized data set in order to be meaningful by a collapsed Gibbs sampler.

As shown in FIG. 2, the icons 44 are not labeled or associated with any specific linguistic topic, but are merely identified by a number indicating the prevalence of each respective topic in the selected textual model. The prevalence of each respective topic is defined by the number of documents within the data set of the selected textual model that have been grouped into the respective topic. Each document may be included in multiple topics. As shown in FIG. 2, the icons 44 are also sized to indicate the prevalence of the topics in the data set. For example, the icon 44 representing Topic 1 is the largest of all of the icons 44 and the icon representing Topic 20 is the smallest of all of the icons. Thus, each icon 44 is sized in relation to the number of documents within the topic represented by the icon 44 and Topic 1 has the most documents of the twenty topics represented by icons 44 in FIG. 2 and Topic 20 has the least documents of the twenty topics represented by icons 44 in FIG. 2.

An icon size scale 46 is provided at the bottom left corner of the intertopic distance map 40 shown in FIG. 2. Icon size scale 46 provides a representation of the predefined relationship between icon size and a percentage of the documents that are related to the topic represented by the respective icon 44. In the icon size scale 46 shown in FIG. 2, icon size scale includes example circles indicating the size of icons associated with 2%, 5% and 10% of the documents in the data set of the selected topic model. By visually comparing the icon 44 representing Topic 1 in FIG. 2 to the icon size scale 46, it is apparent that Topic 1 is associated with approximately slightly greater that 10% of the documents in the data set of the selected topic model. By visually comparing the icon 44 representing Topic 20 in FIG. 2 to the icon size scale 46, it is apparent that Topic 20 is associated with approximately 2% of the documents in the data set of the selected topic model.

Intertopic distance map 40 also displays the interrelatedness or difference of the topics represented by the icons 44 by overlapping icons 44 of topics that are associated with the same documents, and spacing icons 44 from other icons 44 when there is no similarity. For example, the icons 44 representing Topic 1 and Topic 4 overlap to a large degree, a greater degree than the icons 44 representing Topic 13 and Topic 19. Accordingly, Topics 1 and 4 have larger number of documents in common that Topics 13 and 19. In other words, Topics 1 and 4 appear together in more documents than Topics 13 and 19. Additionally, Topics 9, 10 and 16 all appears in documents together and thus Topics 9, 10 and 16 overlap each other. Topic 8 also overlaps with Topics 3, 14 and 18, appearing in almost all of the documents including Topic 18. Topic 15 does not overlap any topics and is spaced from all other topics, indicating the Topic 15 is a rather distinct topic.

Intertopic distance map 40 displays icons 44 based on multidimensional scaling, which involves projecting of icons 44 to a 2-dimensional plane, such that the distances between icons 44 are preserved as much as possible. More specifically, icons 44 represent topics and the distance between two topics is computed as the inverse of the number of words the two topics have in common. Due to the high-dimensional nature of the points, there is no 2D representation of all the bubbles that matches all the distances perfectly. Thus, multidimensional scaling is used to provide an approximation: an optimization is made to find the 2D representation that conserves the distances as much as possible.

The number of terms displayed in term list 42 is controlled via topic size delimiter 38 in panel 34. In FIG. 2, thirty terms are shown in the terms graph 42. The display of terms graph 42 is directed related to the operations of the user in intertopic distance map 40. Terms graph 42 illustrates the representativeness of the data set and the individual topics, which involves a mix of how often terms appear in the topic and how distinct the terms are in the topic versus other topics. When none of the icons 44 or topics is selected on intertopic distance map 40, the most salient terms in the data set are displayed in the terms graph 42. When one of the icons 44 is selected, the most relevant terms in the topic corresponding to the selected icon 44 are displayed in terms graph 42. In the view of FIG. 2, because none of the icons 44 has been selected by the user, the term saliency is shown for the entire data set displayed in intertopic distance map 40. The ordinate of the terms graph 42 displays the most salient or relevant terms and the abscissa of the terms graph 42 displays the frequency of the terms. Above the terms graph 42, GUI 32 includes a relevance delimiter 48 including a button slidable along a scale.

Saliency is computed in the same manner as described in Chuang et al., “Termite: Visualization Techniques for Assessing Textual Topic Models,” Stanford University Computer Science Department (2012). For a given word w, its conditional probability P(T|w) is the likelihood that observed word w was generated by latent topic T and its marginal probability P(T) is the likelihood that any randomly-selected word w′ was generated by topic T. The distinctiveness of word w is defined as the Kullback-Leibler divergence between P(T|w) and P(T):

$$distinctiveness ( w ) = {\sum }_{T}^{ } P ( T \vert w ) log \frac{P ( T \vert w )}{P ( T )} .$$

The saliency of a term is defined by the product of P(w) and distinctiveness (w):

saliency(w)=P(w)×distinctiveness(w).

Saliency is used to display the words in terms graph 42 when no topic represented by icons 44 is selected. As per Chang et al., it is a good measure of the importance of a word to understand the whole corpus. When none of icons 44 is selected, saliency is used to order the terms by showing the top word in a decreasing order.

Relevancy is used to show the words when a topic is selected. Relevancy is computed in the same manner as described in Sievert et al., “LDAvis: A method for visualizing and interpreting topics,” Workshop on Interactive Language Learning, Visualization, and Interfaces at the Association for Computational Linguistics (2014). Relevance of a term w to a topic k given a weight parameter lambda (λ) (where 0≦λ≦1) as:

$$r ( w , k \vert λ ) = λlog ( {φ}_{kw} ) + ( 1 - λ ) log ( \frac{{φ}_{kw}}{{p}_{w}} ) .$$

Relevancy is dependent on the slider bar through the parameter lambda. When lambda is equal to 1, the relevancy is equal to the estimated frequency of the word for the topic, when lambda is equal to 0, the relevancy equal to the estimated frequency in the topic divided by the frequency in the whole corpus. The frequency equals a number of occurrences of the keyword in the total corpus, while the estimated frequency is equal the estimated number of occurrences of the keyword in the topic. It is estimated, because of the nature of the topic model: the topic model is a probabilistic one, which means that a topic is not made out of words precisely, but only in a probabilistic manner.

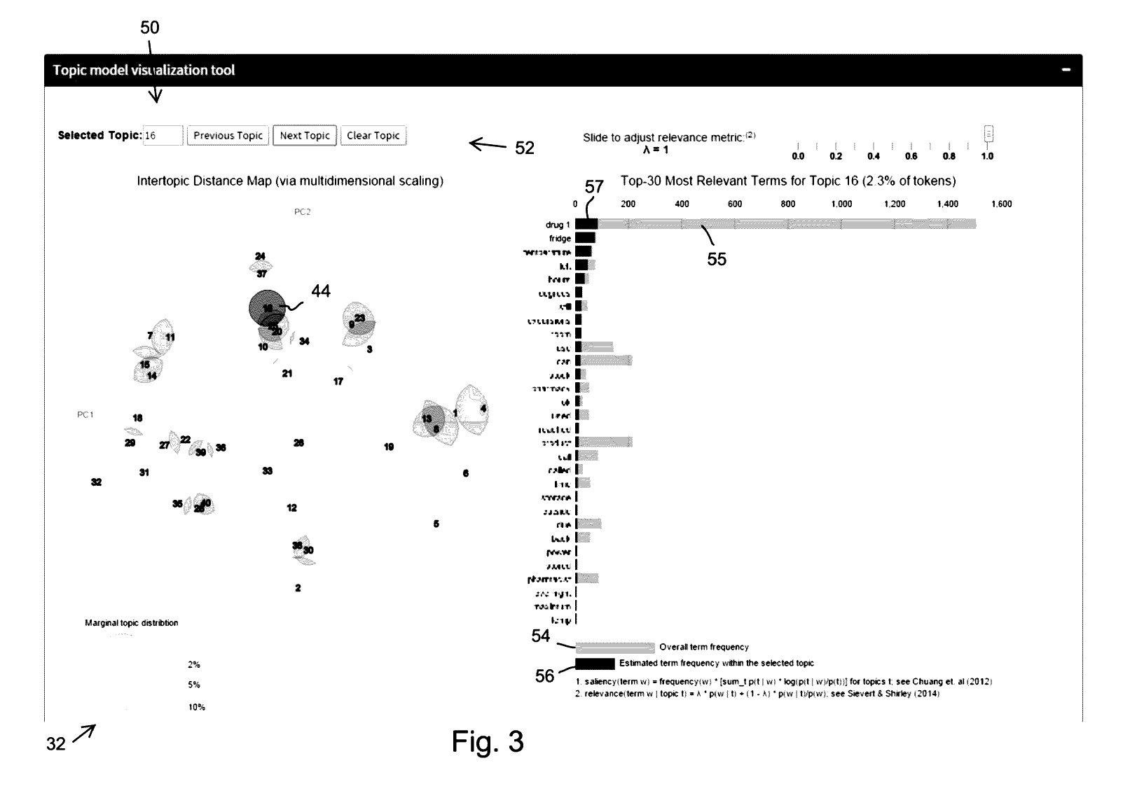

FIG. 3 illustrates a second view of GUI 32, showing GUI 32 upon selection of one of icons 44 of intertopic distance map 40. In this example, the icon 44 representing Topic 16 has been selected by the user by hovering the mouse cursor over the icon 44. In other embodiments, an icon 44 may be selected via clicking on the icon 44 with a mouse or via pressing on it via a touchscreen. Additionally, the topic can be selected via a number input field 50 and selection buttons 52 positioned above intertopic distance map 40 in FIG. 3. Upon selection of one of the icons 44, data related to documents corresponding to the respective topic of the icon 44 is displayed in terms graph 42. In FIG. 3, because the icon 44 representing Topic 16 has been selected, the top thirty most relevant terms in the Topic 16 are shown in term graph 42. Term graph 42 illustrates the representativeness of the terms in Topic 16 by an overall term frequency 54 in a lighter colored bar 55 for each of the top thirty terms and an estimated term frequency within the selected topic 56 in darker colored bar 57. If a term is unique to the selected topic, the darker bar 57 covers a substantial portion of the lighter bar. If a term is more common in the data set, the darker bar 57 only covers a small fraction of the lighter bar 55. In FIG. 3, Drug 1 is commonly used in the data set and thus the estimated term frequency within the selected topic 56 is much greater than the overall term frequency 54 for this term. In contrast, “fridge” is unique to the selected topic and thus the estimated term frequency within the selected topic 56 is equal to the frequency 54 for this term. GUI 32 thus creates a first impression of topics within the data and allows a user to review the data and use the relationships shown to create a taxonomy using the second application 14.

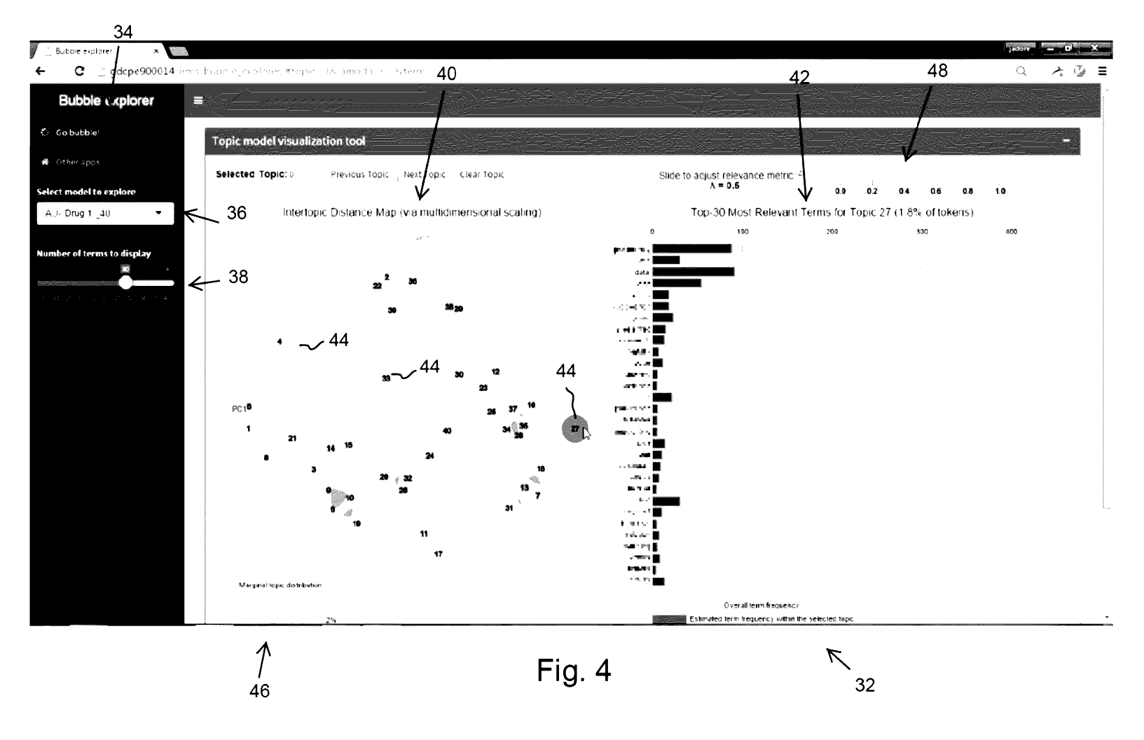

FIG. 4 illustrates a third view of GUI 32, showing GUI 32 upon selection of one of icons 44 of intertopic distance map 40. For the example shown in FIG. 4, the selection made in drop-down menu 36 has been changed to such that the selection still relates to the Drug 1 and the geographic region of Australia, but forty topics are now illustrated by icons 44. In the example of FIG. 4, the icon 44 representing Topic 27 has been selected by the user and term graph 42 indicates that “data” is the most frequent term in Topic 27.

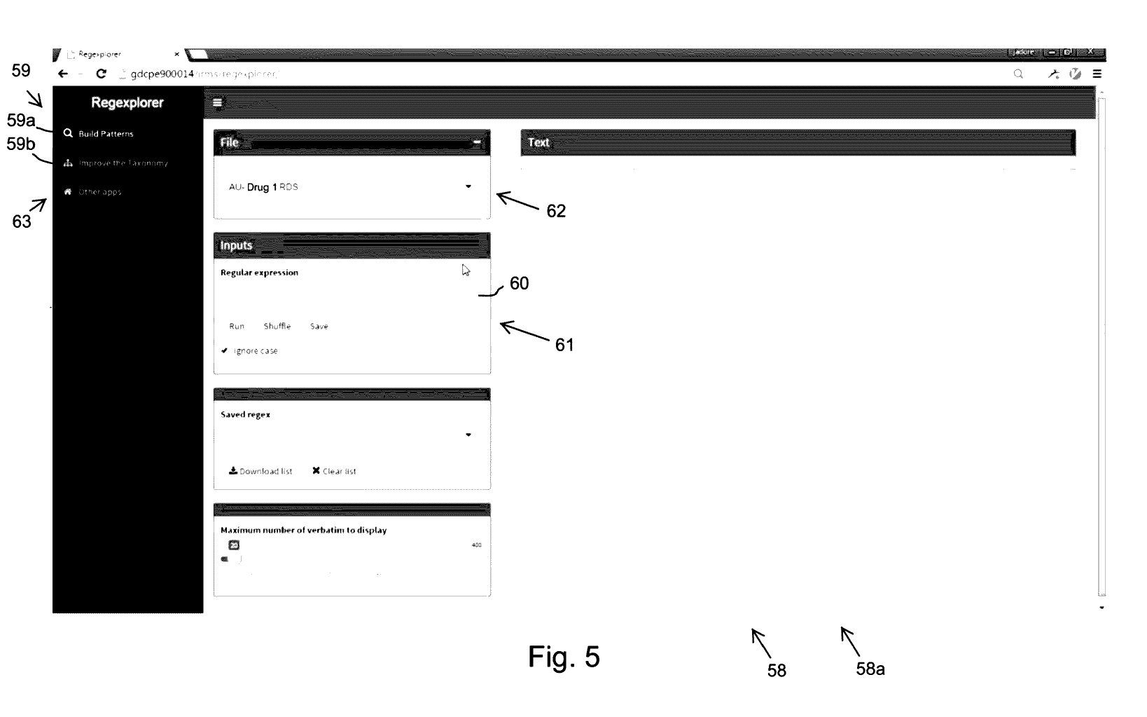

FIG. 5 illustrates a first view of a second application GUI 58 generated by second application 14 according to the exemplary embodiment of the present invention. The second application GUI 58—i.e., a taxonomy modifier GUI—allows a user to search through the documents of a selected corpus and modify an existing taxonomy, or alternatively to create a new taxonomy. The taxonomy modified or created in second application GUI 58 is then retrievable in each of third through sixth applications 16, 18, 20, 22 to analyze the data within the corpus. A user may exit GUI 58 and return to main GUI 10 to interact with the other applications 12, 16, 18, 20, 22 by selecting a home icon 63 shown in an upper left hand portion of FIG. 5.

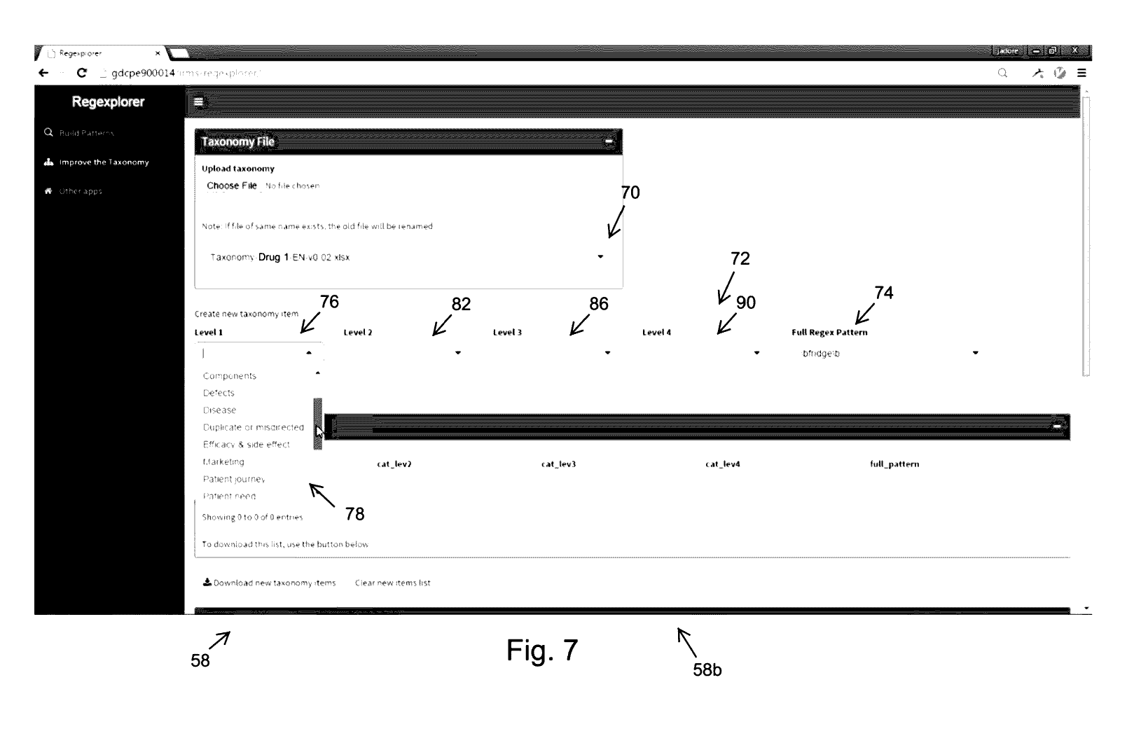

Above home icon 63, second application GUI 58 includes a tool selection pane 59 allowing a user to toggle between two interrelated sections, which include a first section 58a—i.e., a pattern building tool (shown in FIGS. 5, 6, 11, 12, 15)—and a second section 58b—i.e., a taxonomy improvement tool (shown in FIGS. 7 to 10, 13, 14, 16, 17) to modify or create a taxonomy. The user may select first section 58a by selecting a pattern building icon 59a or select second section 58b by selecting a taxonomy improvement icon 59b.

As noted above, the view in FIG. 5 shows pattern building tool 58a, which allows a user to enter a pattern, which in the this embodiment is a regular expression, to search for specific keywords in the data by entering keywords and other regular expression syntax search modifiers into an input pattern field 60 of a search window 61 for text searching a specific model defining a corpus of documents selected via a model delimiter in the form of a drop-down menu 62. Similar to drop-down menu 36 of GUI 32, drop-down menu 62 lists a plurality of models, each defined by a healthcare treatment product of interest and a geographic region. For the example shown in FIG. 5, the selection made in drop-down menu 62 relates to Drug 1 and the geographic region of Australia. After a user has reviewed the relationships generated in GUI 32, the user may have a good understanding of the content of the data set of the selected model and may search for patterns in the selected model via search window 61.

A user may have developed unique insights from the data as viewed in first application GUI 32. Using these insights, the user may search for specific keywords or other patterns using pattern building tool 58a and add the keywords to the taxonomy using taxonomy improvement tool 58b. A user reviewing the data in first application GUI 32 may notice a correlation between two or more terms as expressed in the topic modeler and update a taxonomy accordingly. For example, a user may notice a previously unknown correlation between the terms “mistake,” “freezer” and “caregiver”. For this correlation, the user may search through the documents using pattern building tool 58a and see if the documents support the correlation. If many documents describe that a caregiver has made the mistake to put Drug 1 in the freezer, the user can save search terms or other patterns using pattern building tool 58a and then update the taxonomy using taxonomy improvement tool 58b.

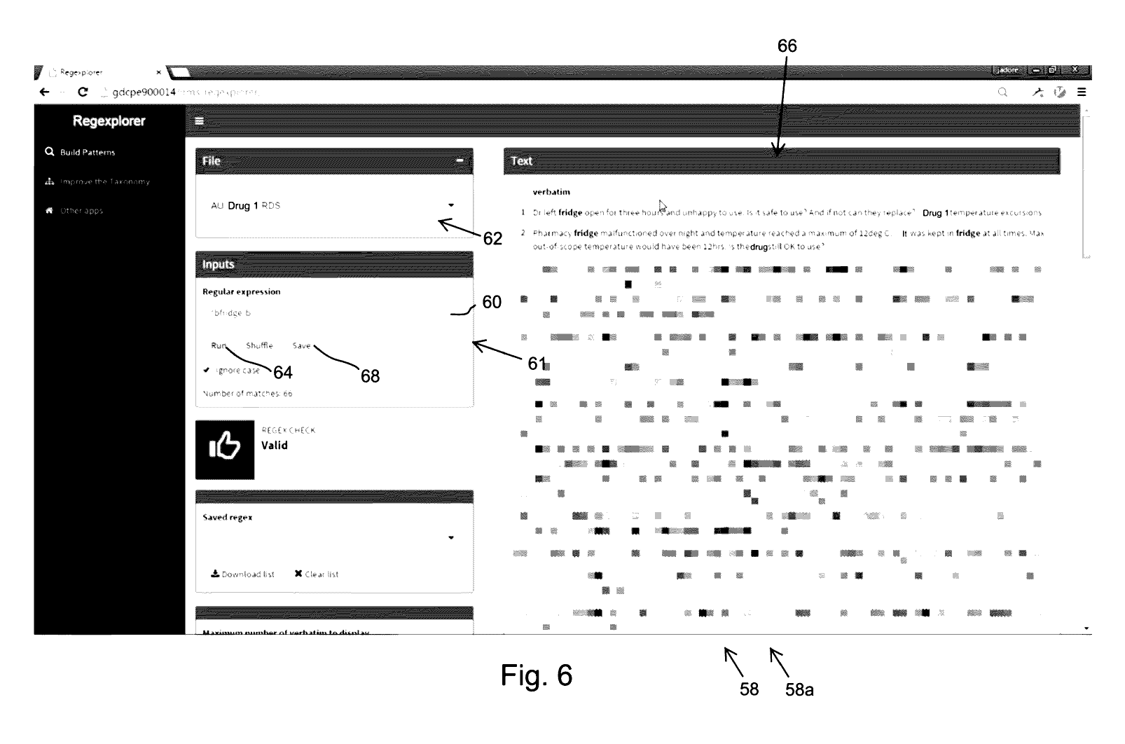

As shown in FIG. 6, the user has typed the regular expression “\bfridge\b” into input pattern field 60 of pattern building tool 58a so that the search only produces instances of the exact expression “fridge.” The user then has selected a run button 64 to initiate the search. Upon the search initiation, a list of the verbatim text from the documents of the data set generated by the entered pattern—“fridge”—appears in a text panel 66 on GUI 58, with the entered pattern “fridge” being signified by bolding in the verbatim text. In other embodiments, the patterns by be signified by other signifiers accenting the entered pattern, such as underlining, highlighting or italicizing. If the user is satisfied that the search results may be helpful in analyzing the data set, the user may save the entered pattern by selecting the save button 68 in search window 61 to add the entered pattern to the taxonomy. After the entered pattern has been saved, the user may select taxonomy improvement icon 59b to switch the display on GUI 58 to taxonomy improvement tool 58b.

FIG. 7 shows the view of GUI 58 displaying taxonomy improvement tool 58b. Taxonomy improvement tool 58b includes a taxonomy file delimiter in the form of a drop-down menu 70 allowing a user to select and modify an existing taxonomy file, which in this embodiment is saved as an XLSX file, related to the textual model selected in drop-down menu 62. After a taxonomy file is selected, the terms saved via pattern building tool 58a may be added to the selected taxonomy.

Taxonomy improvement tool 58b also includes a taxonomy modifier 72 including a pattern delimiter 74 in the form of a drop-down menu and a plurality of category delimiters 76, 82, 86, 90. The drop-down menu 74 lists all previous saved patterns saved via search window of pattern building tool 58a. For the example shown in FIG. 7, the selection made in drop-down menu 74 is the pattern “\bfridge\b” as discussed above. Selecting this pattern via the pattern delimiter 74 allows the user to add the pattern to the taxonomy. After the pattern is selected, the user may create a new taxonomy item by linking the pattern to existing levels of the taxonomy or by typing a new word into the drop-down menu 74. The taxonomy shown in FIG. 7 includes four different levels, including a highest level (“Level 1”), a second highest level (“Level 2”), a second lowest level (“Level 3”) and a lowest level (“Level 4”), which together with the taxonomy as a whole, define five different classes of the data set (i.e., the taxonomy as a whole is a first class and the four different levels are each a class). A first level delimiter 76 is configured to allow the user to select the high level category, as shown in a drop down menu 78, that the user believes most accurately categorizes the selected pattern.

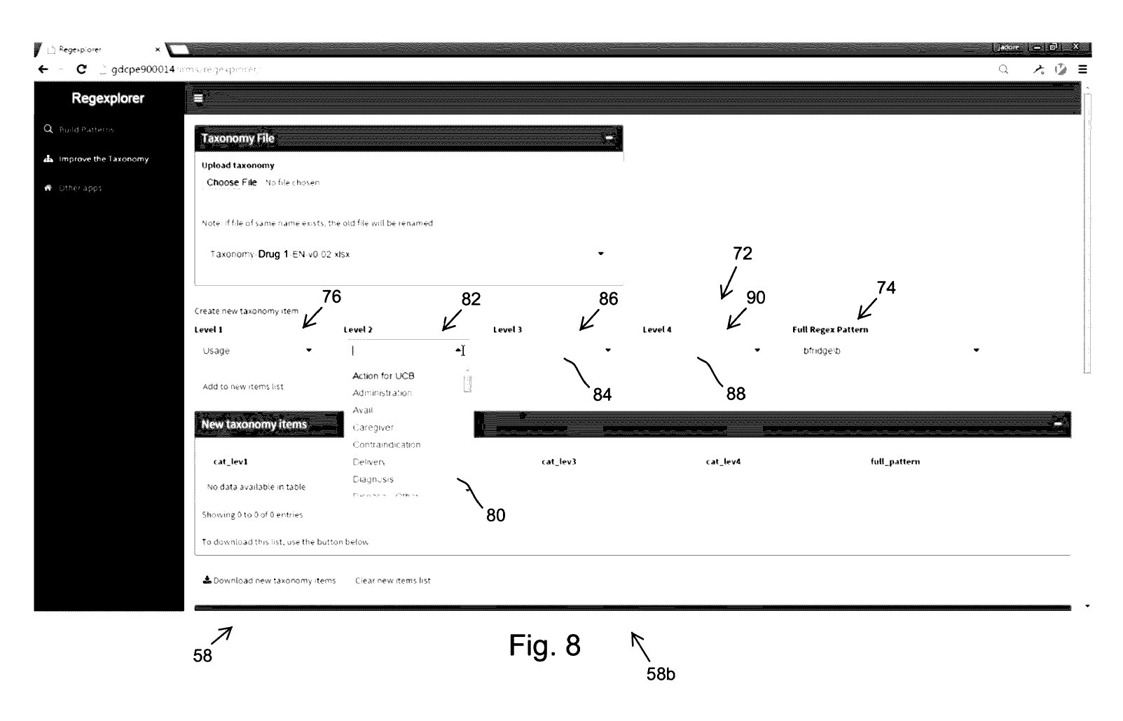

As shown in FIG. 8, in this example, the user believed that the pattern “\bfridge\b” is best described as being within the category “Usage.” After the first level delimiter 76 is used to select the highest level category, a drop down menu 80 is generated in a second level delimiter 82 corresponding to subcategories of the selected highest level category. For example, as shown in FIG. 8, some of the subcategories of the selected category “Usage” includes “Action for UCB,” “Administration,” “Availability” and “Caregiver.” Similar to with the first level delimiter, second level delimiter 82 is configured to allow the user to select the second highest level category, as shown in a drop down menu 80, that the user believes most accurately categorizes the selected expression. Then, after the second highest category is selected, the user may use a drop down menu 84 of a third level delimiter 86 and then a drop down menu 88 of a fourth level delimiter 90 to allow the user to further select the second lowest level category and then the lowest level category that the user believes most accurately categorize the selected pattern.

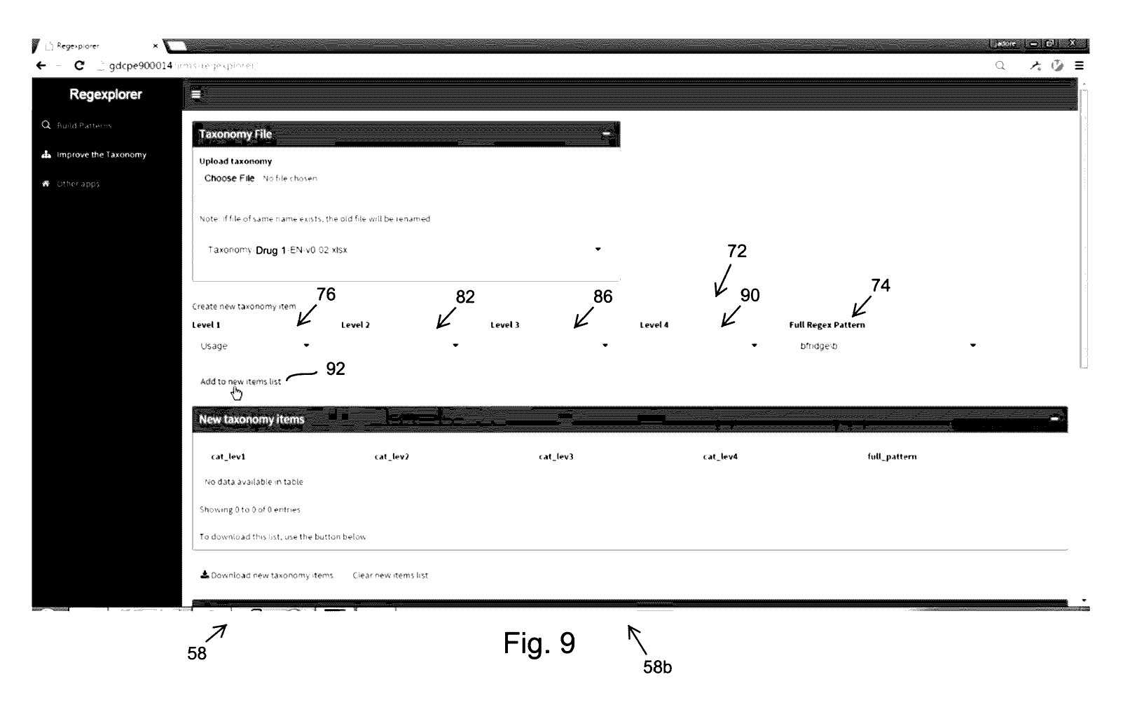

As shown in FIG. 9, after one or more of the category delimiters 76, 82, 86, 90 have been used to categorized the selected pattern, a taxonomy updater, for example taxonomy update button 92, which is labeled (“Add to new item list”), may be selected to add the new categorization to the taxonomy. The new keyword may be added to the selected taxonomy file, which was selected via drop-down menu 70, either automatically or after approval of an administrator.

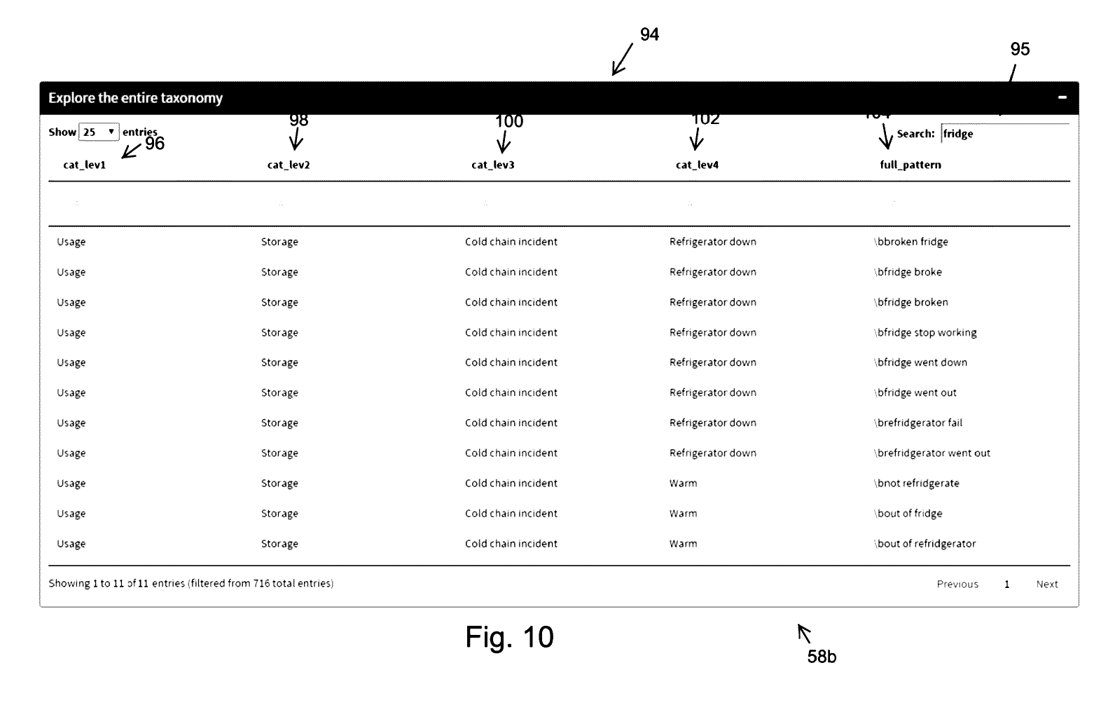

FIGS. 10 to 17 shows a further example of how to use pattern building tool 58a and taxonomy improvement tool 58b, illustrating the interplay between the two tools of taxonomy modifier GUI 58. FIG. 10 shows a view of taxonomy improvement tool 58b illustrating the defined categories of the original taxonomy selected via drop-down menu 70 in a taxonomy display section 94. Taxonomy display section 94 displays categories in response to a taxonomy search input entered into a taxonomy search field 95. Upon entry of the taxonomy search input, the categories related to the taxonomy search input are generated in taxonomy display section 94. In response to this taxonomy search input, a plurality of category level display sections 96, 98, 100, 102 display hierarchy of categories related to the taxonomy search input. As shown in FIG. 10, display sections 96, 98, 100, 102 are organized into columns in this embodiment decreasing in the level of taxonomy from left to right and the rows of taxonomy display section 94 represent patterns in alignment with the taxonomy levels generated by the taxonomy search input.

In the example shown in FIG. 10, there are seventeen results generated for the taxonomy search input of “fridge.” In response to this taxonomy search input, a first level display section 96 displays the highest level—i.e., Level 1—category of “Usage” and a second level display section 98 displays a Level 2 category of “Storage,” which is a subcategory of “Usage,” associated with the input of “fridge.” Accordingly, only one first level categories is generated from the input of “fridge” and only one second level category of this first level category is associated with “fridge.” A third level display section 100 lists the Level 3 subcategories of the selected Level 2 categories—“Storage”—in alphabetical order. A fourth level display section 102 lists the Level 4 subcategories of the selected Level 3 categories—“Refrigerator down” and “Warm”—in alphabetical order.

To the right of fourth level display section 102, a pattern display section 104, which is also organized as a column, is provided. Pattern display section 104 displays patterns that are associated with the lowest level of the taxonomy shown in taxonomy display section 94. In the example shown in FIG. 10, the lowest level categories displayed are the Level 4 categories of “Refrigerator down” and “Warm.” The category of “Refrigerator down” is associated for example with the patterns of “\bbroken fridge” and “\bfridge broke” and the category of “Warm” is associated for example with the patterns of “\bnot refridgerate” and “\bout of fridge.” When the taxonomy search input of “fridge” was entered into taxonomy search field 95, the rows are generated such that each row includes a pattern saved with the taxonomy and each level of the taxonomy associated with the pattern. For example, in FIG. 10, the top row includes the pattern “\bbroken fridge,” the Level 4 category “Refrigerator down” the Level 3 category “Cold chain incident,” the Level 2 category “Storage” and the Level 1 category “Usage.” Taxonomy display section 94 thus allows a user to see the current categories associated the input term “fridge” and to add further patterns and associated categories to the taxonomy if the user deems the current categories insufficient.

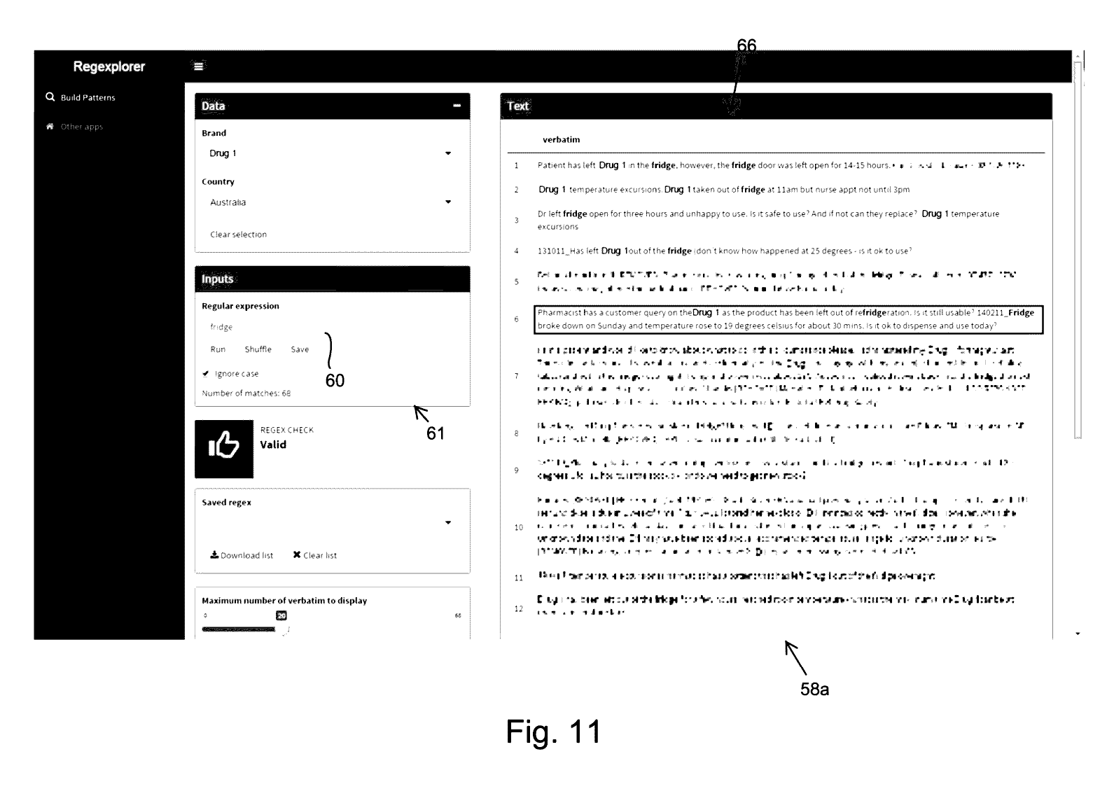

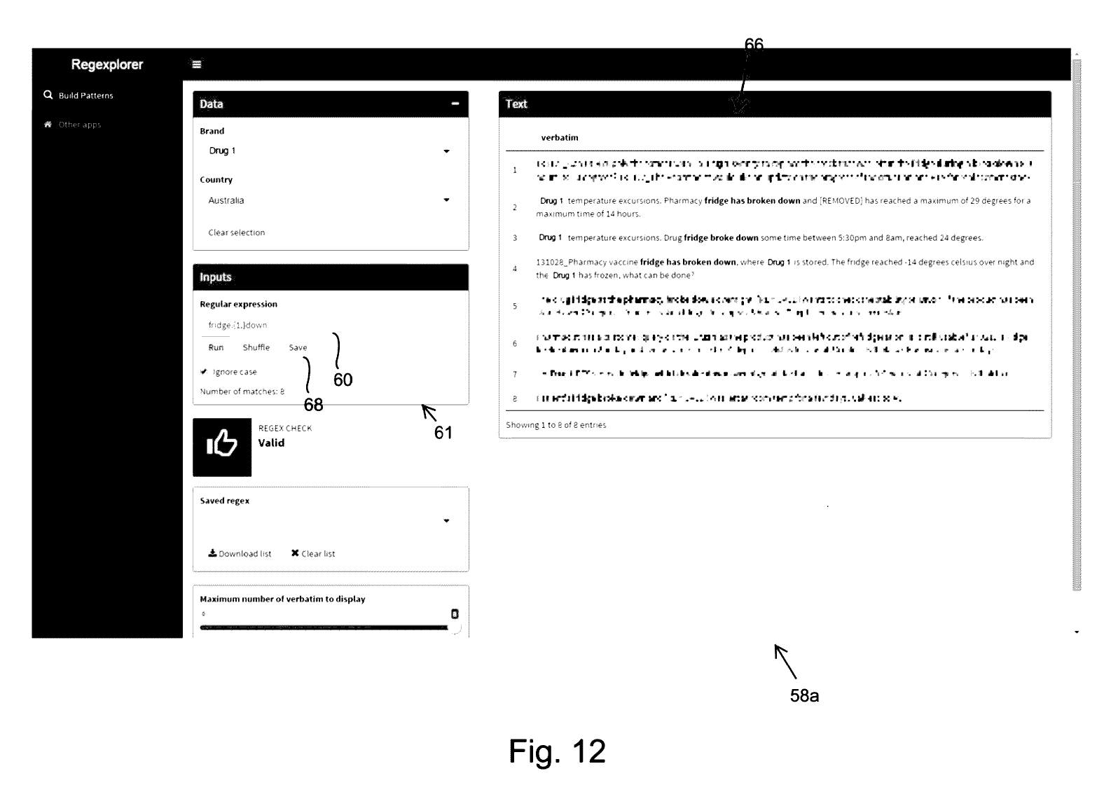

A user may then return to pattern building tool 58a to search for further patterns that may be added to the taxonomy. As shown in FIG. 11, the user may search the selected corpus using the pattern “fridge” to what contexts “fridge” appears in corpus and to determine if additional patterns should be added to the taxonomy shown in taxonomy display section 94 in FIG. 10. Upon entering “fridge” in input pattern field 60 and selecting the “Run” button of search window 61, a list of the verbatim text from the documents of the data set generated by the “fridge” appears in text panel 66. The user may then notice that the phrase “fridge broke down” appears in one of the documents displayed in text panel 66 and is not a saved pattern in the taxonomy shown in FIG. 10. As shown in FIG. 12, the user may then enter the pattern “fridge. {1,} down” in input pattern field 60 and select the “Run” button of search window 61 to generate a list of the verbatim text from the documents including “fridge. {1,} down” in text panel 66. In response, seven documents including “fridge. {1,} down” are shown in text panel 66. The user may review the text and if the user believes “fridge. {1,} down” should be added to the taxonomy, the user may save the entered pattern “fridge. {1,} down” by selecting the save button 68. The user may then select the taxonomy improvement icon 59b and switch back to taxonomy improvement tool 58b.

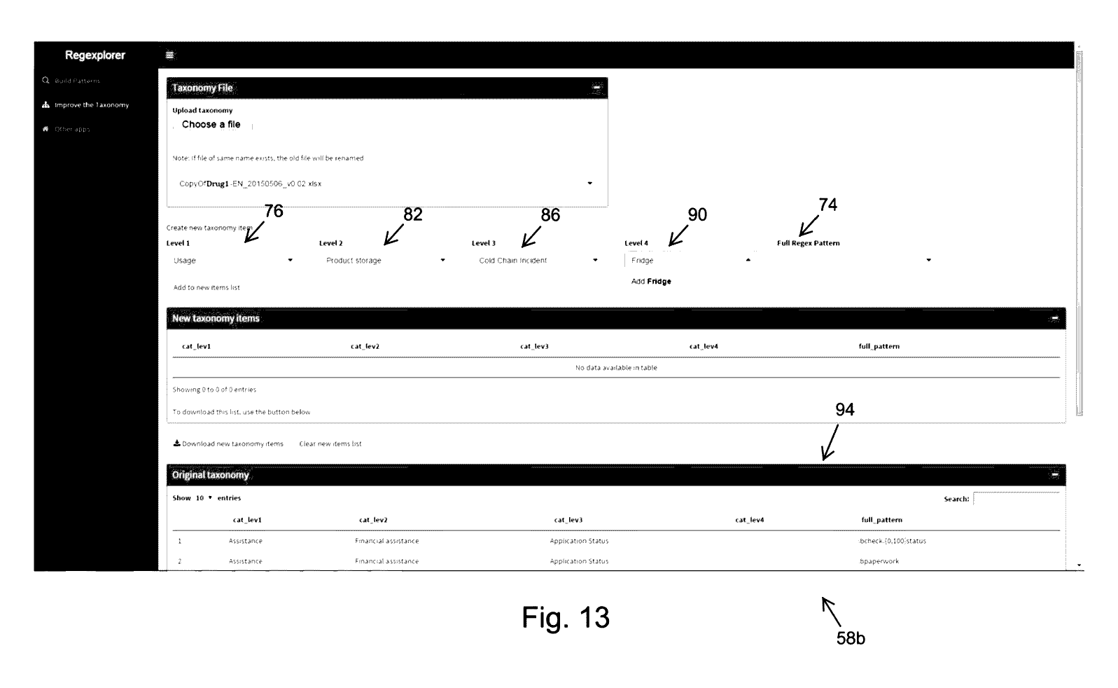

As shown in FIG. 13, the user may then specify the categories to which the pattern “fridge. {1,} down” is to be added by selecting “Usage” with first level delimiter 76, selecting “Product storage” with second level delimiter 82 and selecting “Cold Chain Incident” with third level delimiter 86. The user may believe that none of the current Level 4 categories under “Cold Chain Incident” is appropriate with which to associate the pattern “fridge. {1,} down.” The user may then add a new Level 3 category by typing “Fridge” into fourth level delimiter 90, and selecting “Add Fridge” from a drop down menu generated after “Fridge” is typed into fourth level delimiter 90.

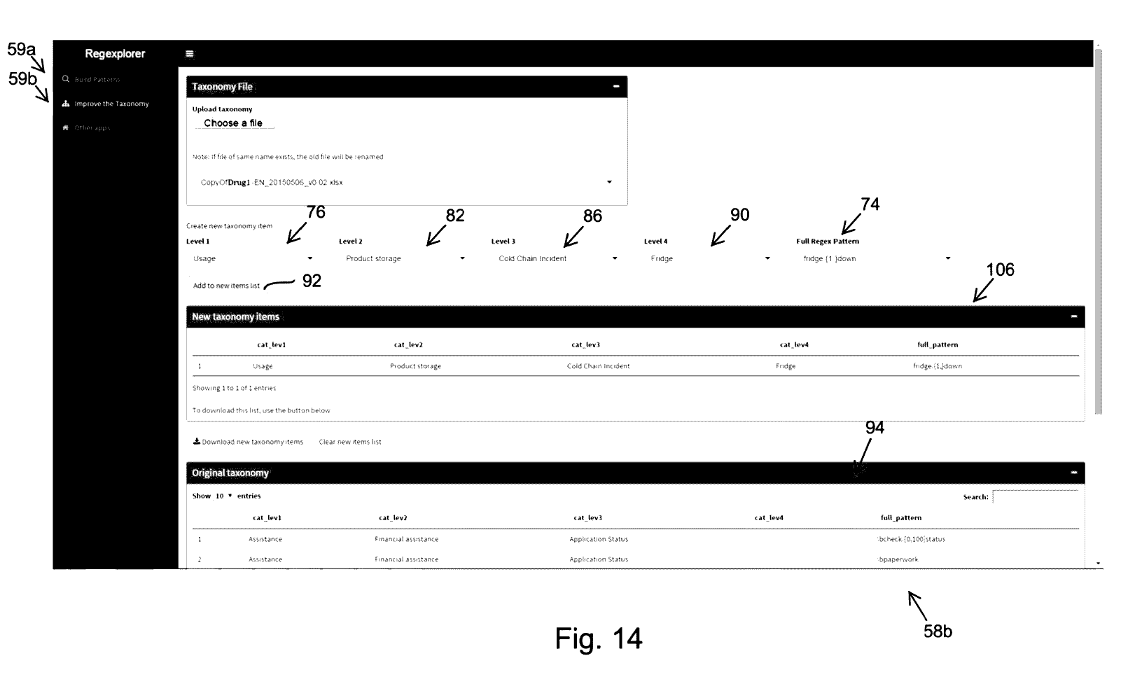

Next, as shown in FIG. 14, the user may then link the pattern “fridge. {1,} down” to the new Level 4 category by selecting “fridge. {1,} down” from the drop-down menu of pattern delimiter 74. Saving the pattern “fridge. {1,} down” as discussed above by selecting the save button 68 of pattern building tool 58a causes “fridge. {1,} down” to be generated in the drop-down menu of pattern delimiter 74. Accordingly, saving the pattern “fridge. {1,} down” in search window 61 of pattern building tool 58a allows the pattern “fridge. {1,} down” to be added to the original taxonomy in taxonomy improvement tool 58b. After the new desired categories and/or patterns have been added with delimiters 74, 76, 82, 86, 90, the taxonomy update button 92, may be selected to add the new categorization to the taxonomy. Selecting a pattern with pattern delimiter 74, and then saving the pattern, causes the pattern selected via delimiter 74 to be linked to the lowest level category delimited in taxonomy modifier 72. The pattern selected via delimiter 74 is linked to the Level 4 category “Fridge,” which is in turn linked to the Level 2 category “Product Storage” and the Level 1 category “Usage.” Accordingly, the pattern is linked to the lowest level category delimited in taxonomy modifier 72 and all of the categories higher that that lowest level category via the lowest level category. As shown in FIG. 14, after the new categorization has been added to the taxonomy, the pattern and the associated categories are displayed in taxonomy addition display section 106 to inform the user of the patterns and associated categories that have been successfully added by the user.

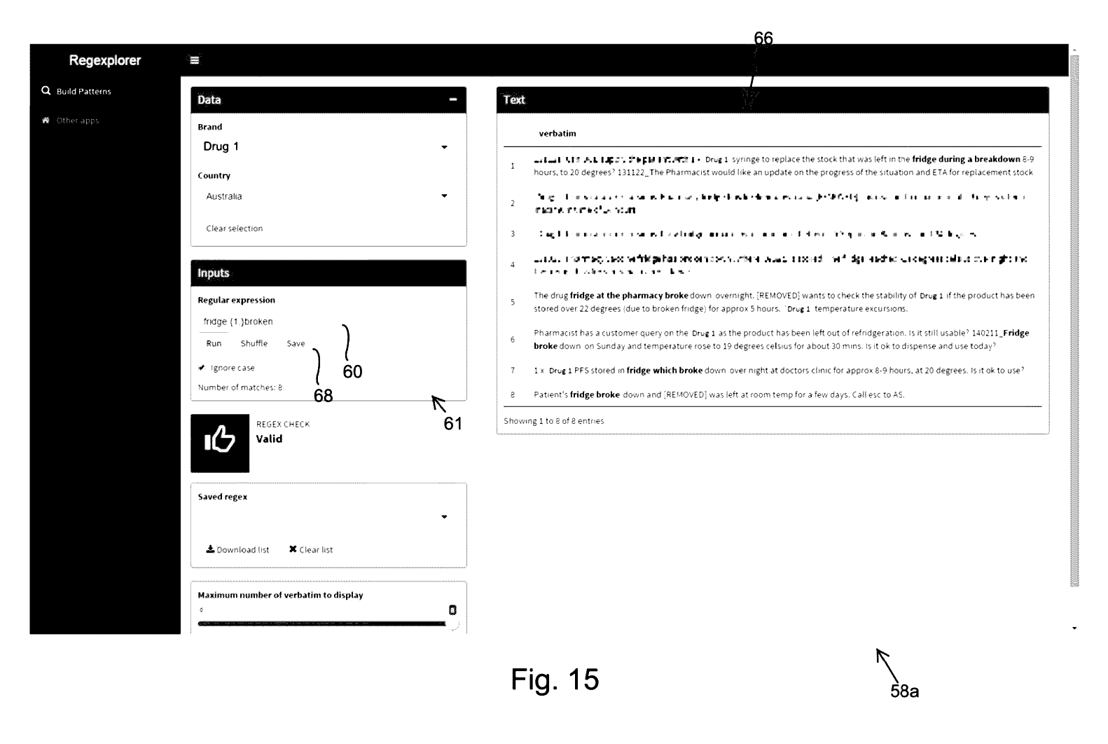

To add another pattern/category set, the user may select pattern building icon 59a to switch back to pattern building tool 58a. As shown in FIG. 15, the user may search for the pattern “fridge. {1,}broken” by entering it into input pattern field 60 to generate documents including phrases such as “fridge has broken,” “fridge during a breakdown” and “fridge broke” in text panel 66. If the user believes this pattern should be added to the taxonomy, the user saves the entered pattern “fridge. {1,}broken” by selecting the save button 68. The user may then select the taxonomy improvement icon 59b and switch back to taxonomy improvement tool 58b.

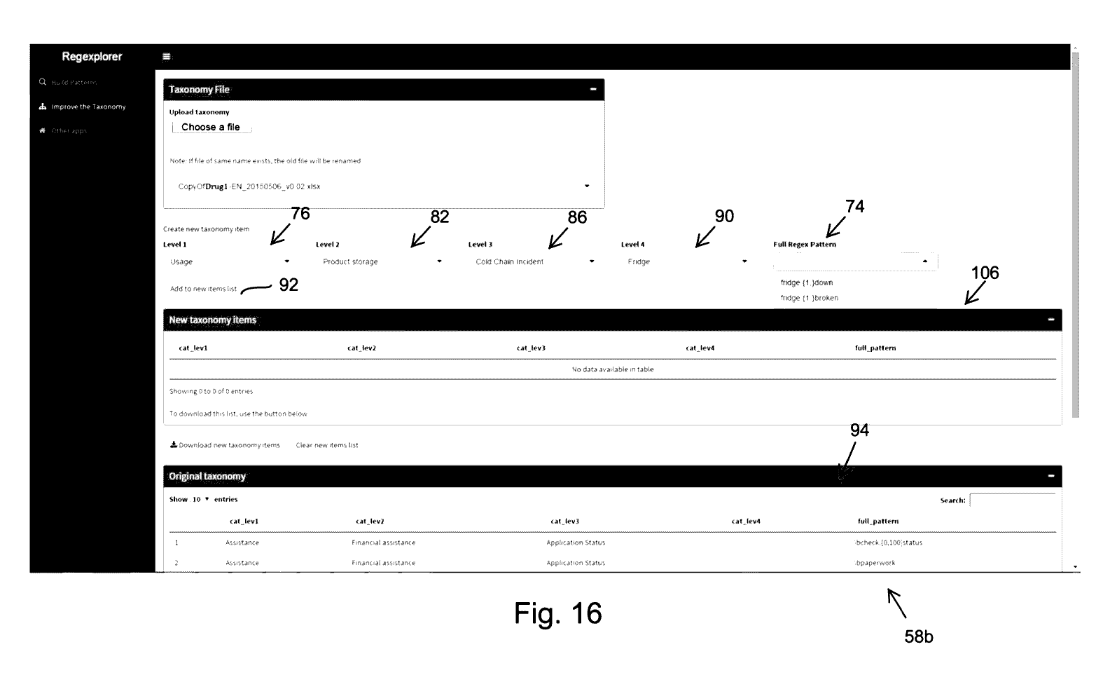

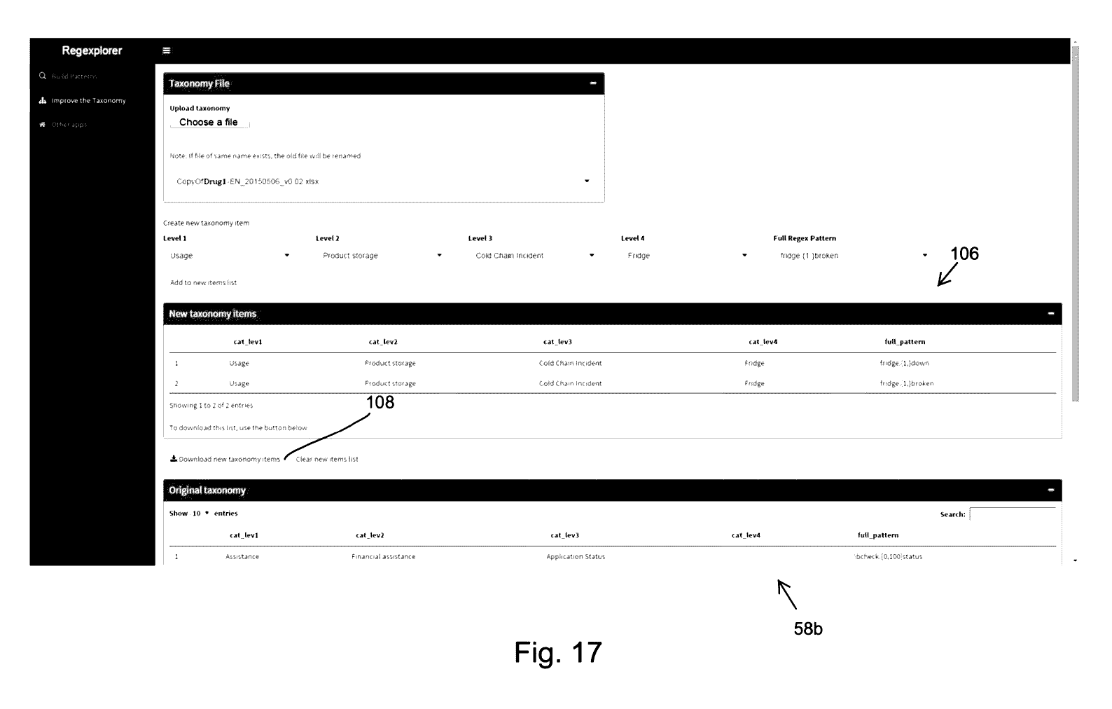

As shown in FIG. 16, the user may then user taxonomy modifier 72 to specify the categories to which the pattern “fridge. {1,}broken” is to be added by selecting “Usage” with first level delimiter 76 and selecting “Product storage” with second level delimiter 82, “Cold Chain Incident” with third level delimiter 86 and “Fridge” with fourth level delimiter 90. Accordingly, adding new taxonomy categories to taxonomy addition display section 106 causes the new categories to be generated in and be selectable in category delimiters 76, 82, 86, 90 of taxonomy modifier 72. As also shown in FIG. 16, the user may then link the pattern “fridge. {1,}broken” to the Level 4 category by selecting “fridge. {1,}broken” from the drop-down menu of pattern delimiter 74. Next, the may user may select taxonomy update button 92 to add the new categorization to the taxonomy. As shown in FIG. 17, after the new categorization has been added to the taxonomy, the pattern and the associated categories are displayed in taxonomy addition display section 106 to inform the user of the patterns and associated categories that have been successfully added by the user. When a user is ready to add the new categorizations to the selected taxonomy file, the user may the select the taxonomy addition button 108, which is label “Download new taxonomy items” in FIG. 17. The new categorizations may be added to the existing taxonomy file either automatically or after approval of an administrator.

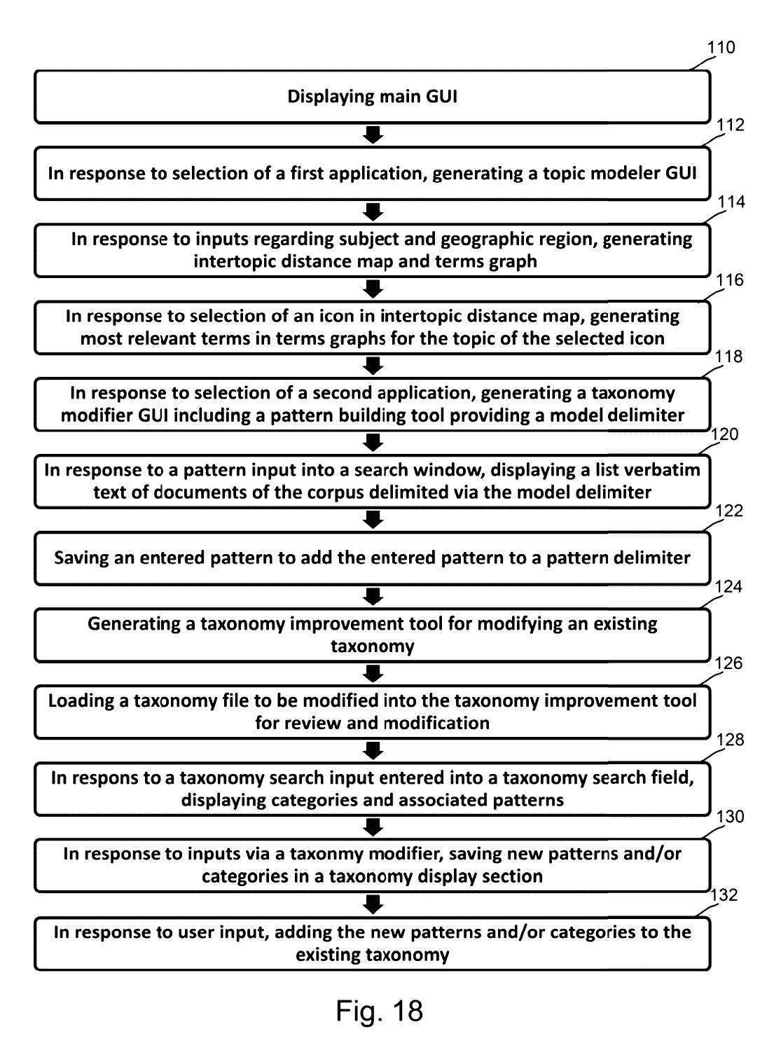

FIG. 18 shows a flow chart of a method of searching and organizing a healthcare textual data set in accordance with the topic modeler GUI 32 described with respect to FIGS. 1 to 4 and the taxonomy modifier GUI 58 described with respect to FIGS. 5 to 17. The method includes a first step 110 of displaying main GUI 10 displaying six different applications 12, 14, 16, 18, 20, 22. A next step 112 includes, in response to a selection of first application 12, generating topic modeler GUI 32, including panel 34 allowing a user to select a textual model defining a corpus of documents to explore and a number of terms to display. Next, in a step 114, in response to inputs of the user in panel 34 regarding the healthcare treatment product of interest and geographic defining the corpus and the input regarding the number of terms to display, intertopic distance map 40 and terms graph 42 are generated on GUI 32. As noted above, the intertopic distance map 40 utilizes a LDA implementation to display icons 44 illustrating relationships between latent topics of a raw uncategorized data set and the terms graph 42 displays the term saliency is shown for the entire data set displayed in intertopic distance map 40. In a step 116, upon the selection of one of the icons in intertopic distance map 40, terms graph 42 is modified to display the most relevant terms in the topic corresponding to the selected icon 44.

Then, after the user has selected and reviewed the data for a sufficient number of different icons 44 in intertopic distance map 40 to appreciate the relationships of the keywords and topics in the selected corpus, a next step 118 includes, in response to a selection of first application 14 on main GUI 10, generating pattern building tool 58a of taxonomy modifier GUI 58, including model delimiter 62 allowing the user to select the textual model displayed in the topic modeler GUI 32. Step 118 also includes generating a search window 61 on pattern building tool 58a allowing a user to enter a pattern to search for specific instances of the pattern in the documents of the corpus defined by the selected textual model. Next, in a step 120, in response to the pattern input into search window 61, taxonomy modifier GUI 58 displays a list of the verbatim text from the documents of the data set including the entered pattern. Reviewing the verbatim text allows the user to get a sense of the context of the pattern and allows the user to determine if the pattern should be saved or whether another pattern appearing in the verbatim text should be searched and/or saved. In a step 122, a pattern is saved in response to an input of the user, in particular by selecting the save button 68 in search window 61 to add the entered pattern to taxonomy improvement tool 58b, in particular to add to the entered pattern to pattern delimiter 74.

In a step 124, taxonomy improvement tool 58b is generated by selection of taxonomy improvement icon 59b. Step 124 includes generating the taxonomy file delimiter 70 allowing a user to select and modify an existing taxonomy file, generating the taxonomy modifier 72 for adding new patterns and/or categories to the taxonomy and generating taxonomy display section 94 for displaying defined categories of the original taxonomy. In a step 126, in response to the selection of an existing taxonomy file via taxonomy file delimiter 70, the selected taxonomy file is loaded into taxonomy improvement tool 58b for review and modification. In a step 128, in response to a taxonomy search input entered into a taxonomy search field 95, taxonomy display section 94 displays categories and associated patterns related to the entered taxonomy search, which allows a user to discover the current patterns and also areas where there is room for improvement of the current patterns. In a step 130, in response to inputs of the user via taxonomy modifier 72, new patterns and categories may be saved in a taxonomy addition display section 106. Then, in a step 132, in response to the user's selection of the taxonomy addition button 108, the new categorizations may be added to the existing taxonomy file either automatically or after approval of an administrator.

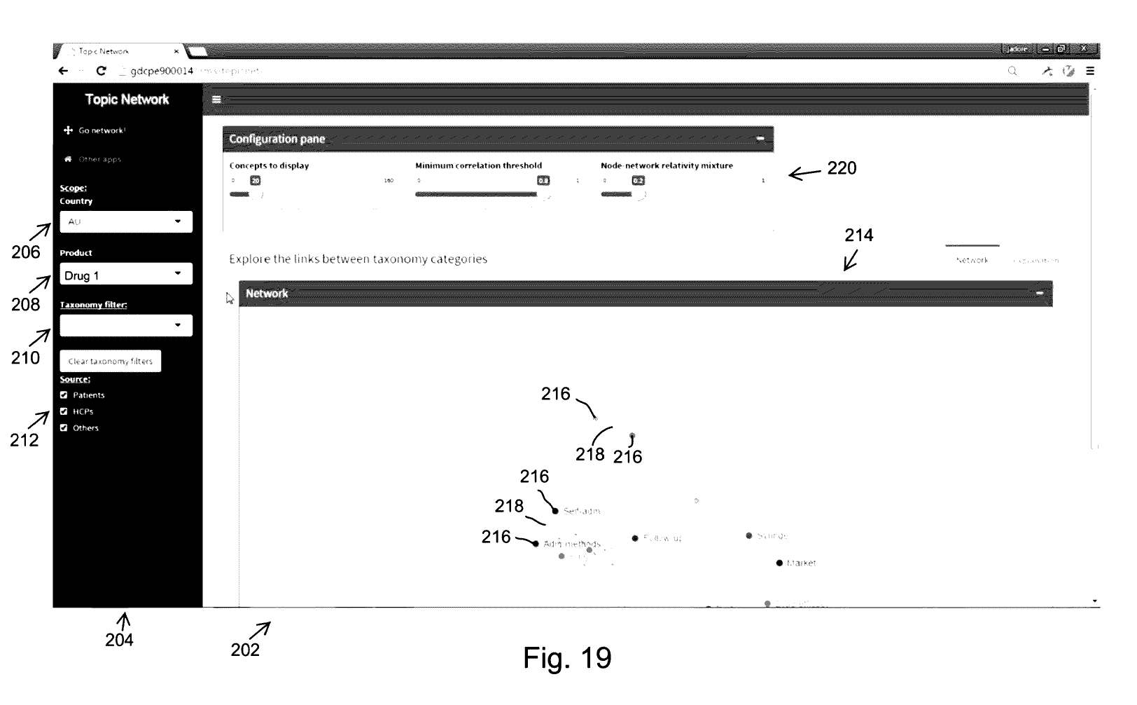

FIG. 19 illustrates a first view of a third application GUI 202 generated by third application 16 according to the exemplary embodiment of the present invention. The third application GUI 202—i.e., a visual network generator GUI—includes a panel 204 at a left-side region thereof allowing a user to select a textual model defining a corpus of documents to explore and a number of terms to display and to select a taxonomy filter to be applied to the selected textual model. In the embodiment shown in FIG. 19, the textual model is selected from a list of options displayed in a model delimiter in the form of drop-down menus 206, 208. The drop-down menu 206 provides a list of selectable geographic regions and drop-down menu 208 provides a list of selectable healthcare treatment products of interest, allowing the user to delimit the textual model displayed in GUI 202 in terms of a healthcare treatment product in a geographic region. For the example shown in FIG. 19, the selection made in drop-down menu 206 relates to the geographic region of Australia and Drug 1. As noted above with respect to GUI 58, the selected textual model includes textual data in the form of documents including statement from patients and health care professionals in regards to the product, Drug 1, in the geographic region, Australia.

Panel 204 may further include a taxonomy filter 210 in the form of a drop-down menu. Taxonomy filter 210 allows a user to select a specific taxonomy defined by a user using GUI 58. The menu is hierarchical, i.e. once a first filter is selected, a second menu appears with the options for the second filter, and so on. A plurality of additional selection box represents subsequent level of hierarchy in the taxonomy. In the view in FIG. 19, in the first level “People” is selected, and in the second level “Caregiver” is selected, which is a subcategory of “People”—other selectable types may be for example “Patient,” “Doctor” and “Pharmacist” and the third level is empty. If a user selects the third level, different caregiver types, e.g., husband, wife, child and father, etc. are generated in the third level box. If a specific taxonomy is selected with taxonomy filter 210, the information displayed in GUI 202 is limited to the documents related to subcategories of the selected taxonomy. If no specific taxonomy is selected via filter 210, the information displayed in GUI 202 is provided for all of the documents related to Drug 1 in Australia.

Panel 204 also includes a source input section 212 allowing a user to delimit the source of the text displayed in GUI 202. In this embodiment, the user can select patients, health care providers (HCPs) and/or others as being the source of the text. In the view shown in FIG. 19, all of the sources—patients, HCPs and others—have been selected by checking boxes next to the respective sources. “Others” may include for example regulators, payers and insurance employees.

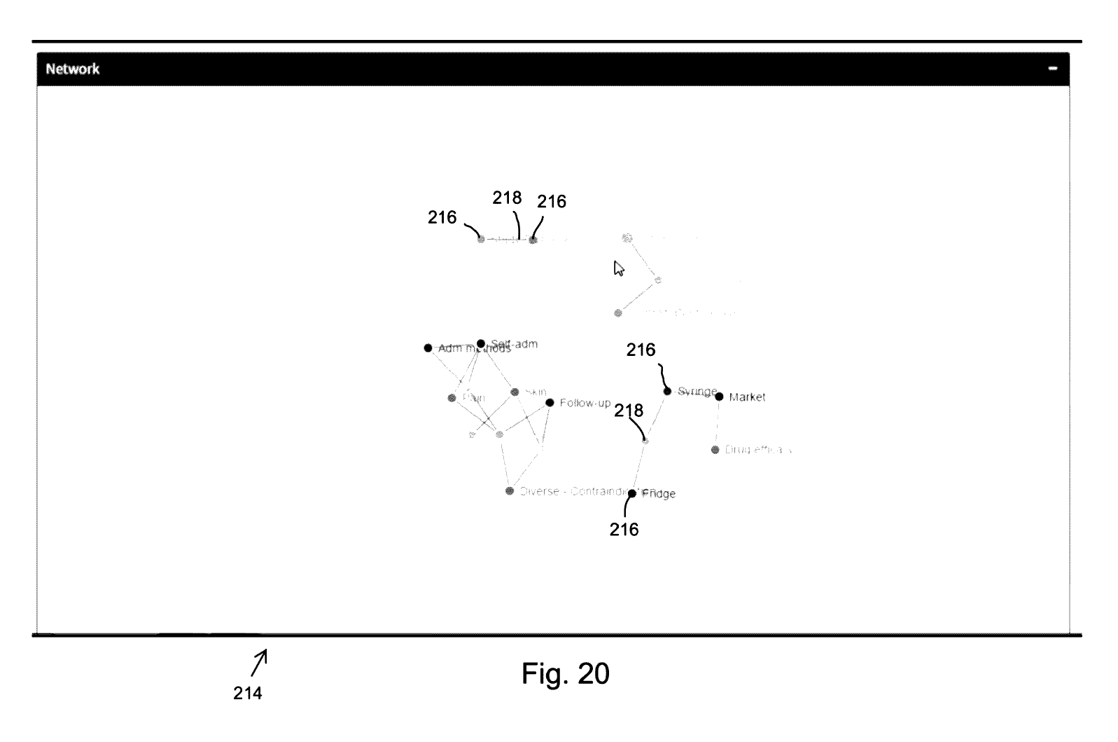

Third application GUI 202 further includes a visual network display section 214 configured for displaying information as a visual network as specified by menus 206, 208, taxonomy filter 210 and source input section 212. FIG. 20 shows an enlarged view of visual network display section 214, which provides for a user review of data that has already be sorted by taxonomy into categories. Visual network display section 214 allows a user to visually explore links between taxonomy categories. Visual network display section 214 displays a plurality of nodes 216 and a plurality of links 218 between the nodes 216 in a two-dimensional space. In order to allow a user to focus on different sections of nodes 216, the visual representation of the network may be modified by dragging the nodes 216 via a mouse cursor or touchscreen. For example, nodes 218 appearing hidden by nodes 218 in front of them in the current display of the visual network may be brought to the front by dragging the hidden node to an empty space in the screen. Each node 216 represent a category of the taxonomy, which is identified by text adjacent to each node 216, and each link 218 represents a connection between two categories. Two nodes 216 are linked by a link 218 if the topics appear together in the documents of textual model specified in panel 204 a sufficient amount of times to satisfy a relationship threshold delimited by link delimiters 228, 234, which are discussed further below.

Visual network display section 214 allows understanding of connections between different topics inside the data. For example, as shown in FIG. 20, a node 216 for the category Pharmacy is connected to a node 216 for the category Syringe by a link 218 and is also connected to a node 216 for the category Fridge by a link 218. A user reviewing the data will be alerted that the product is distributed by pharmacies for administration via a syringe and that the product must be refrigerated at the pharmacy. In the example shown in FIG. 20, the displayed nodes 216 are represented as different colors based on their level of the taxonomy. In this embodiment, the colors are based on the categorization in the highest level—i.e., Level 1—of the taxonomy. Every highest level category is painted in its own color, allowing the user to easily detect unexpected, often interesting, relationships, because different categories appear in different colors. In this example, the nodes 216 for Pharmacy, Syringe and Fridge are all from different levels of the taxonomy and thus are each a different color—the node 216 for Pharmacy being green, the node 216 for Fridge being blue and the node 216 for Syringe being purple. Representing the level of the taxonomy for each node 216 by a specific color allows a user to observe relationships that would not necessarily be intuitive. In contrast, the nodes 216 for the categories of Approved Indications and Rheumatoid Arthritis in this example are the same color—light purple—indicating that the relationship between the two categories is likely known—i.e., Drug 1 is approved for treating rheumatoid arthritis in the specified geography.

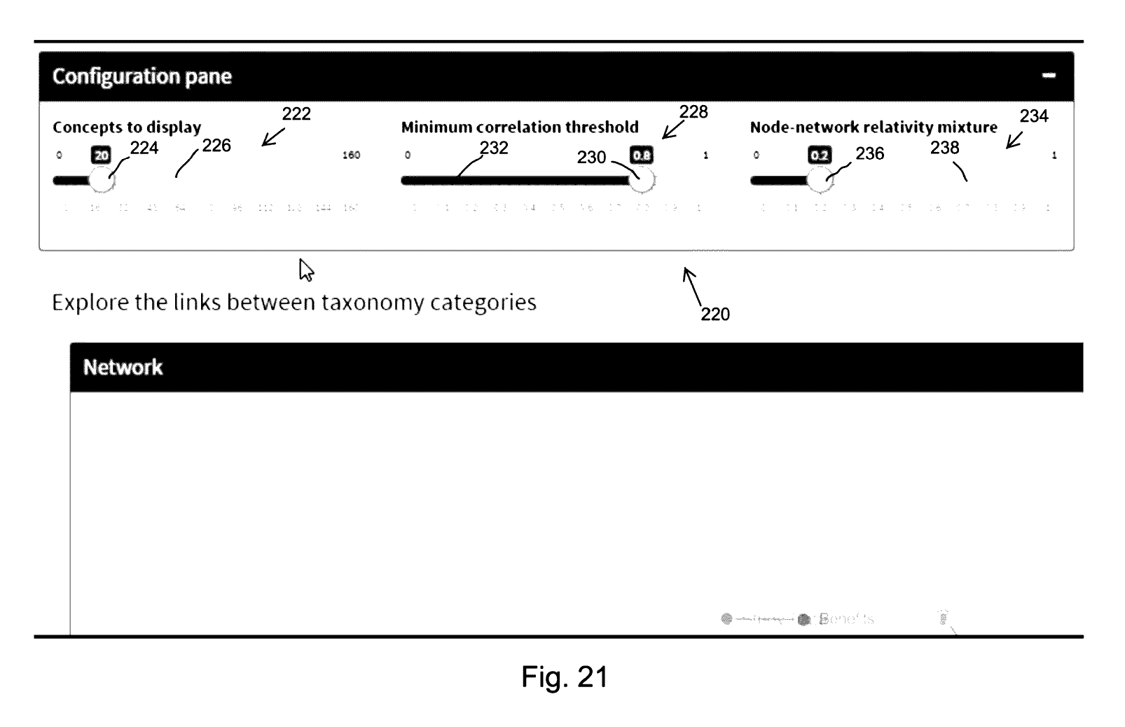

FIG. 21 shows an enlarged view of a configuration pane 220 of third application GUI 202. Configuration pane 220 is configured for adjusting the displaying of nodes 216 and links 218 in visual network display section 214. Configuration pane 220 includes a node number delimiter 222 configured as a button 224 slidable along a scale 226 to select a number of nodes 216 to display in visual network display section 214. Sliding button 224 to the left decreases the number of nodes 216 displayed and sliding button 224 to the right increases the number of nodes 216 displayed. For the example shown in FIG. 21, the selection made via node number delimiter 222 is twenty nodes 216. Correspondingly, the visual network display section 214 illustrated in FIG. 20 shows twenty nodes 216 representing the most popular topics.

Configuration pane 220 also includes link delimiters 228, 234 in the form of a minimum correlation threshold delimiter 228 controlling the generation links 218 between nodes 216. The minimum correlation threshold represents the quantile on which the links are to be filtered, i.e. if the minimum correlation threshold is 0.8, it means generating on display section 214 the links with a correlation of 80% or higher—links in the top 80 percentile. Minimum correlation threshold delimiter 228 is configured as a button 230 slidable along a scale 232 to select a value between 0 and 1 for the minimum correlation threshold. Sliding button 230 to the left, towards 0, increases the number of links 218 displayed (displaying more relatively weaker links) and sliding button 230 to the right, towards 1, decreases the number of links 218 displayed (displaying only the relatively stronger links). For the example shown in FIG. 21, the selection made via correlation threshold delimiter 228 is 0.8. Correspondingly, the visual network display section 214 illustrated in FIG. 20 shows nodes 216 connected to each other if the categories represented by the nodes have a minimum correlation threshold greater than or equal to 0.8.

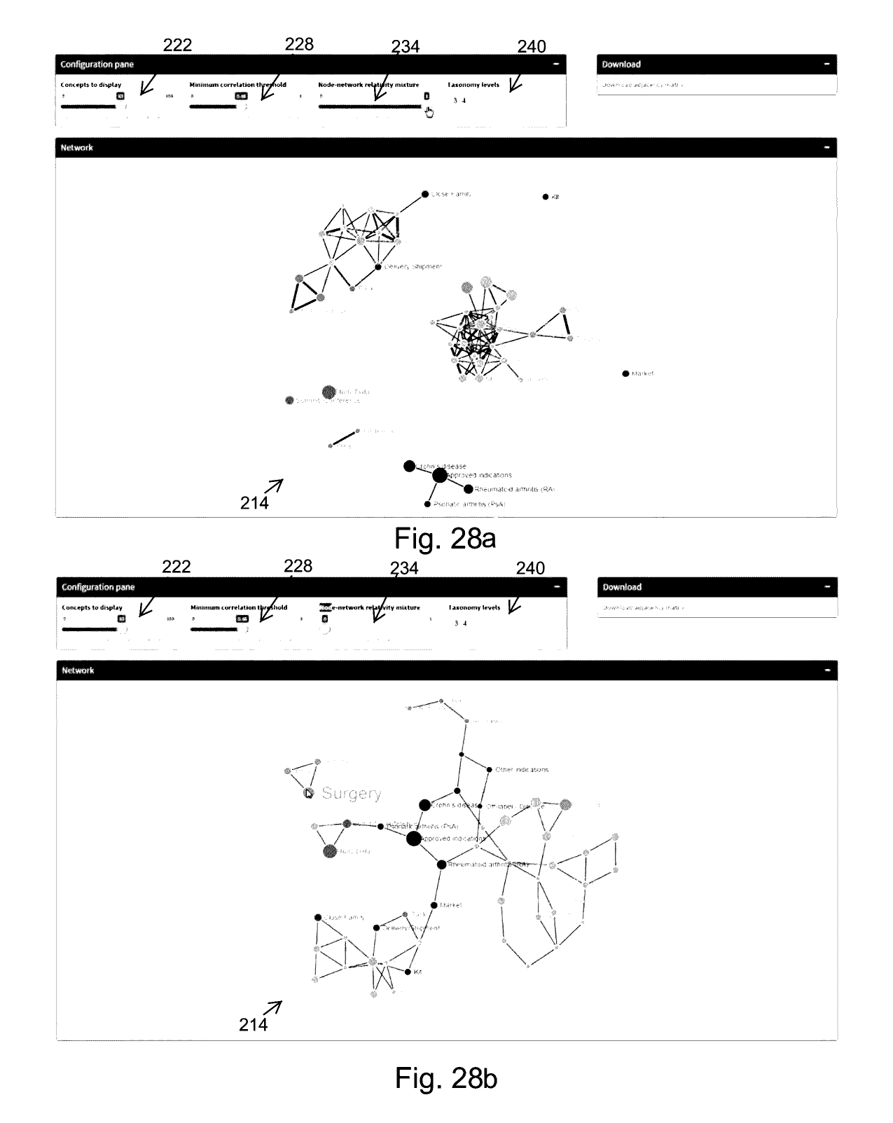

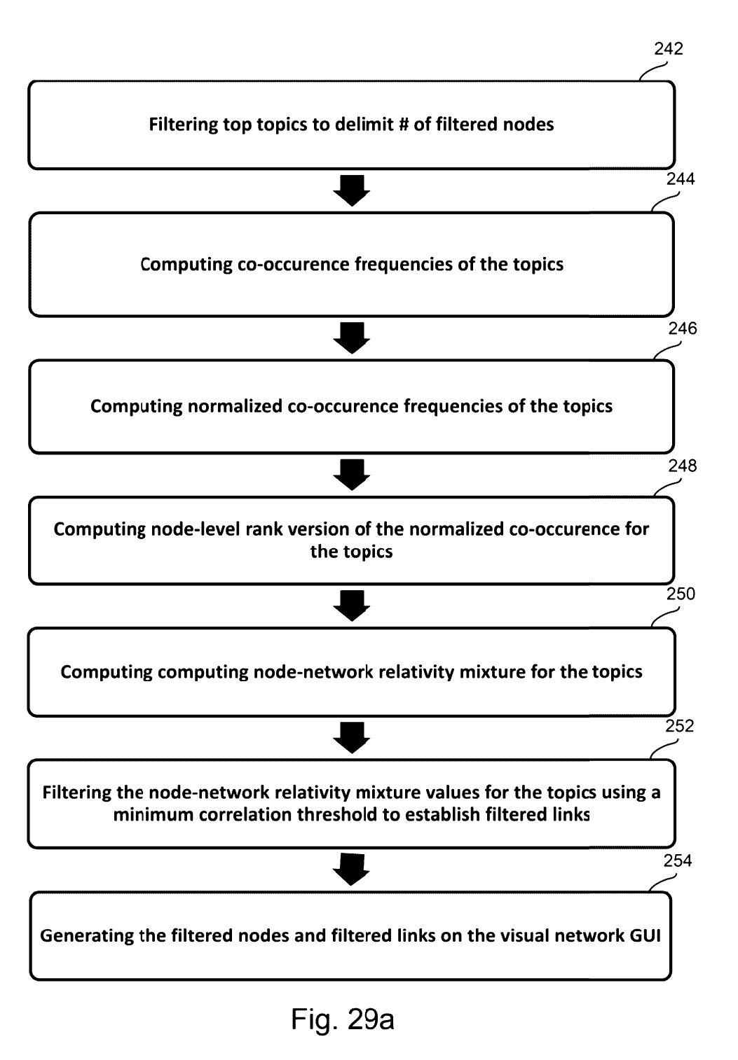

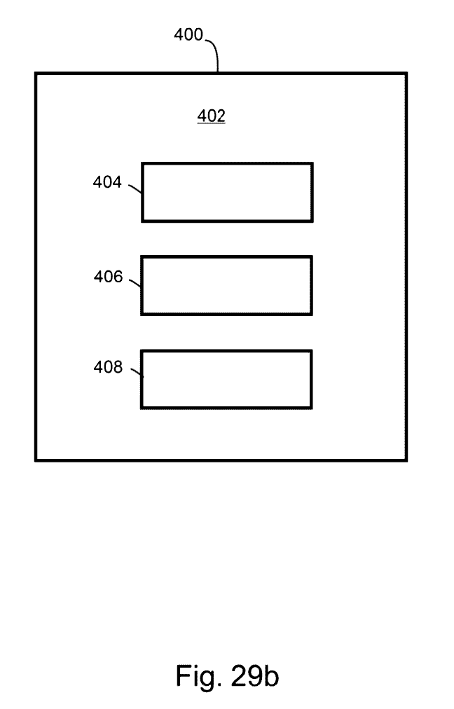

Configuration pane 220 also includes node-network relativity mixture delimiter 234 controlling a parameter determining which computation is made as a basis for generating of the links 218. The node-network relativity mixture, which is discussed further below with respect to FIGS. 28a, 28b and 29, represents a balance (mathematically, a mixture) between two extremes: a value of node-network relativity parameter of 1 means that the correlation is computed as the lift, which is equal to the co-occurrences of two terms divided by the expected co-occurrences if the terms were independent. A value of the node-network relativity parameter of 0 means that a further transformation is applied: the correlation is computed as the rank of the lift of, and each link between two topics is compared to all the other links of the nodes of that link.

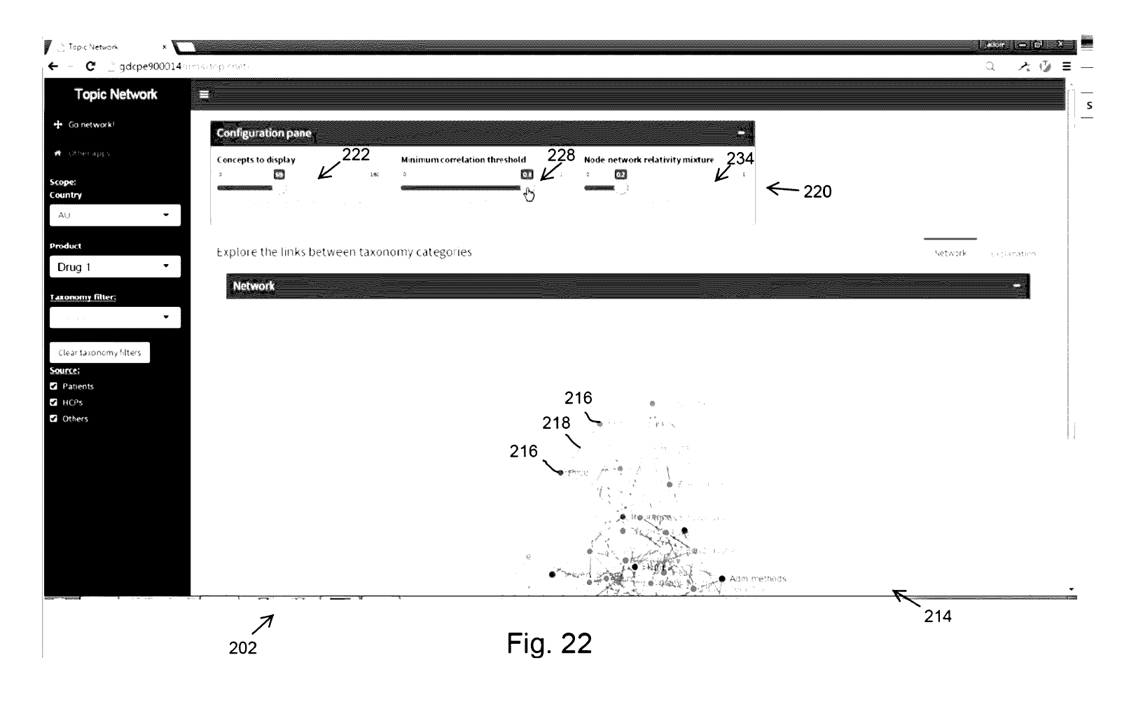

FIG. 22 shows a view of configuration page 220 of third application GUI 202 with node number delimiter 222 being adjusted to increase the number of nodes 216 displayed in visual network display section 214 from twenty, as shown in FIG. 20, to fifty-nine. Accordingly, many more nodes 216, and a result, many more links 218 are displayed in FIG. 22 than in FIG. 20. Increasing the number of nodes 216 generated in GUI 202 allows a user to review a greater set of topics to increase the chances of discovering unknown correlations and decreasing the number of nodes 216 allows a user to more clearly view of the nodes 216 and links 218.

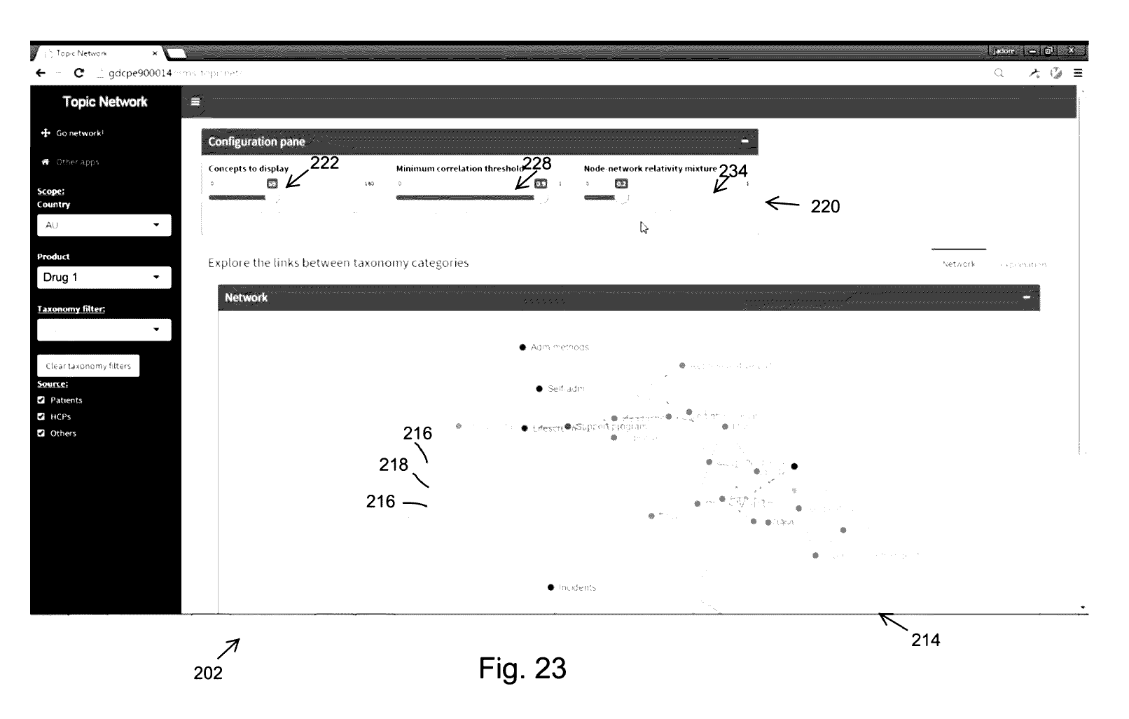

FIG. 23 shows a view of configuration pane 220 of third application GUI 202 with minimum correlation threshold delimiter 228 being adjusted to increase the minimum correlation threshold displayed in visual network display section 214 from 0.8, as shown in FIG. 22, to 0.9. Accordingly, many less links 218 are displayed in FIG. 23 than in FIG. 22. Increasing the minimum correlation threshold, and thus decreasing the number of links 218, generated in GUI 202 allows a user to review only the strongest links between categories, and decreasing the minimum correlation threshold, and thus increasing the number of links 218, generated in GUI 202 allows a user to increase the chances of discovering weaker, but possibly less predictable, correlations.

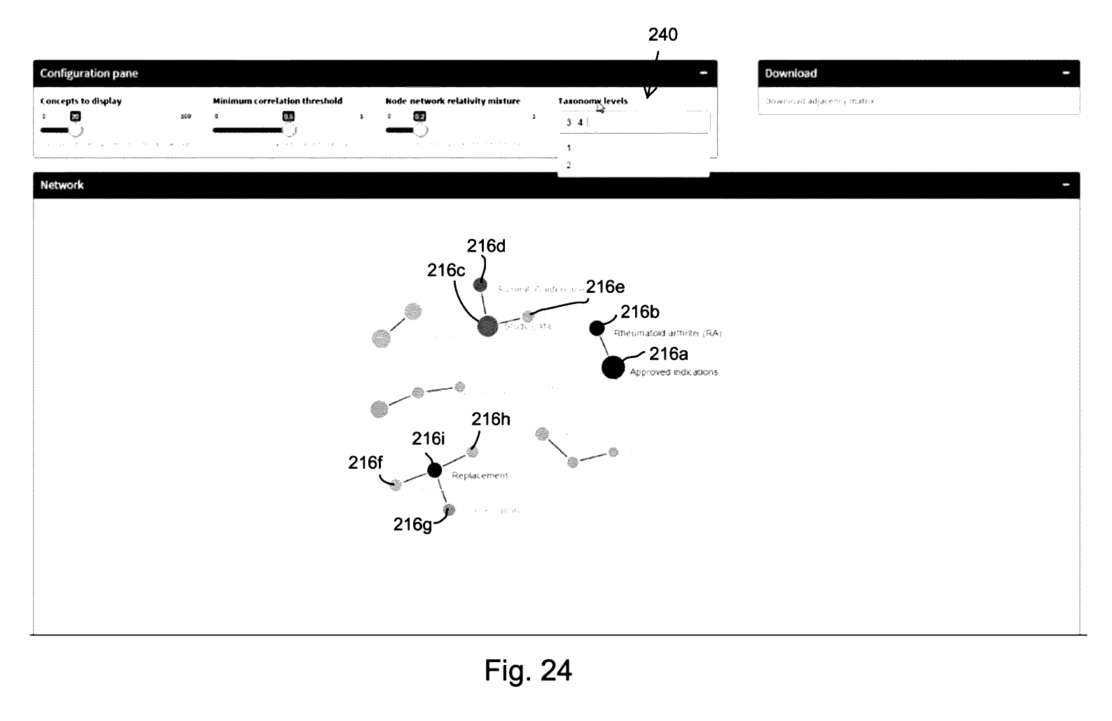

FIG. 24 shows another embodiment of GUI 202. FIG. 24 is different from the embodiment shown in FIGS. 20 to 23 in two key respects. First, in FIG. 24 the sizes of nodes 216 in the network are proportional to the number of documents in which the topic represented by the node 216 is included—i.e., the more documents in which the topic is included, the larger the node corresponding node. Accordingly, in the example shown in FIG. 24, node 216b, which represents the topic “Approved indications” is included in more documents than the other topics and is bigger than the other nodes. Second, in FIG. 24, the taxonomy levels to display are adjustable using a taxonomy display delimiter 240. In this example, as with the example described above with respect to FIGS. 7 to 17, the taxonomy includes four taxonomy levels including a highest level (“Level 1”), a second highest level (“Level 2”), a second lowest level (“Level 3”) and a lowest level (“Level 4”). In the view shown in FIG. 24, Level 3 and Level 4 are selected for display by taxonomy display delimiter 240.

The nodes 216 displayed in FIG. 24 are colored in accordance with their respective Level 1 category. For example, node 216a representing “Approved indications” and node 216b representing “Rheumatoid arthritis” are in the same color of blue, indicating that those nodes 216a and 216b, which area Level 3 or Level 4 categories, are classified under the same Level 1 category as subcategories thereof. Accordingly, the linking of node 216a to nodes 216b is anticipated. For another example, node 216c representing “Study Data” and node 216d representing “Summit conference” are dark orange in color, while node 216e representing “Benefits” is light blue in color. Accordingly, the linking of node 216c to node 216d is anticipated, and the linking of node 216c to 216e should be possibly further reviewed. For another example, node 216i representing “Replacement” is dark green and is linked to a light orange colored node 216h representing “Fridge,” a light orange colored node 216f representing “Administration issues” and a pink colored node 216g representing “Close family.” The linking of these diverse nodes 216f, 216g, 216h to node 216i appears to show that replacement of Drug 1 is tied to refrigeration and administration issues, but also to issues related to close family members.

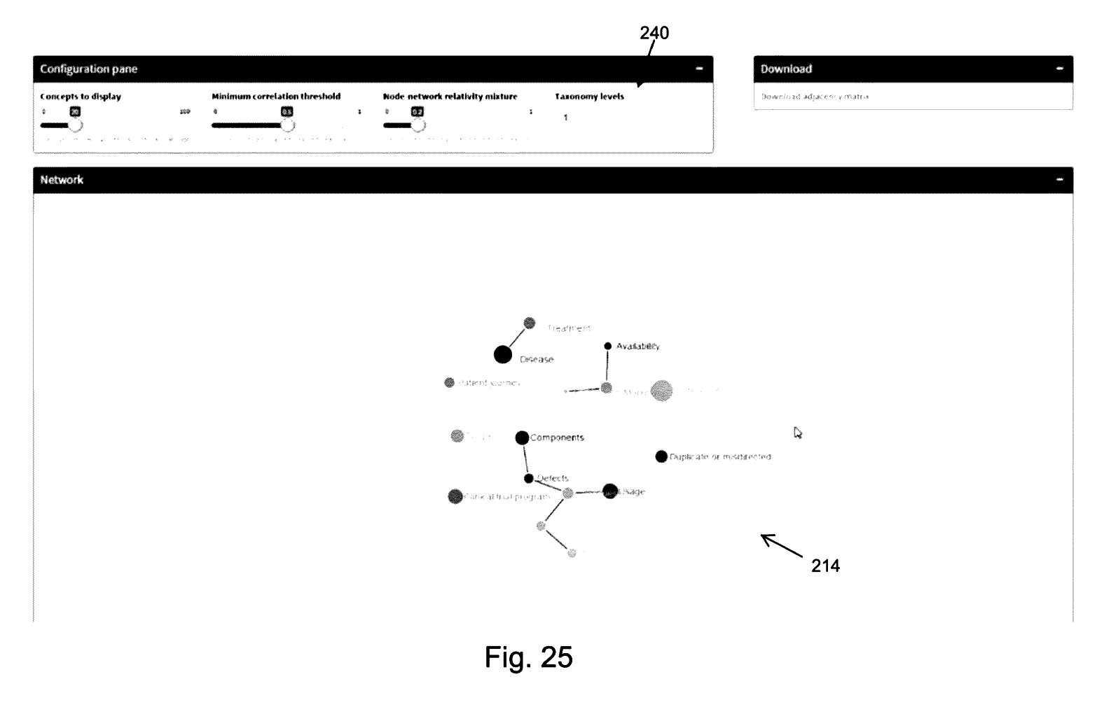

FIG. 25 shows a view of the embodiment shown in FIG. 24 with the selection of taxonomy display delimiter 240 changed from Level 3 and Level 4 in FIG. 24 to Level 1 in FIG. 25. As shown in FIG. 25, selection of Level 1 is less informative that lower Levels 3 and 4, because the Level 1 topics are more general and are linked to less other topics.

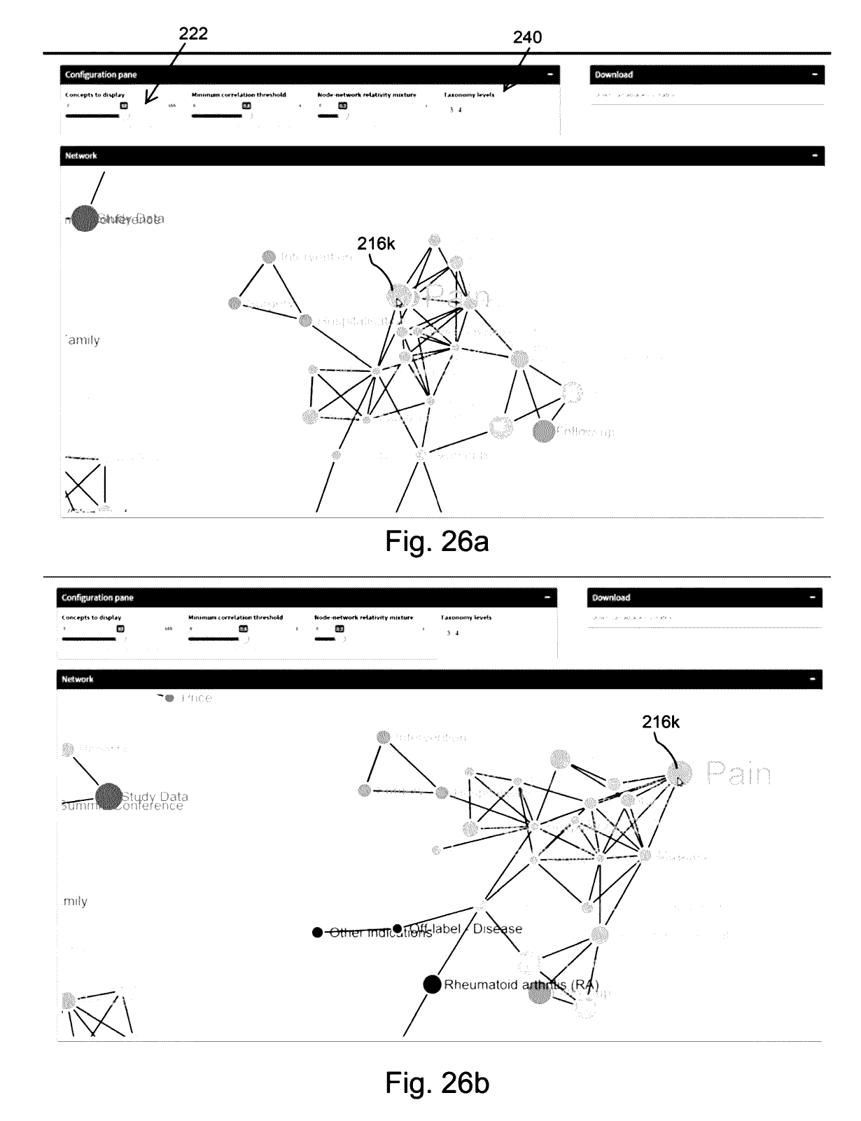

FIGS. 26a and 26b show views of the embodiment shown in FIG. 24 to illustrate how a node 216 of the network may be dragged to modify the view of the network. In the views of FIGS. 26a and 26b, Level 3 and Level 4 have been selected with taxonomy display delimiter 240 and the fifty-three top topics have been delimited via node number delimiter 222. The user has zoomed in on a specific section of the network by scrolling the mouse and node 216k has been selected via the mouse cursor, which increases the size of the topic label “Pain” for node 216k. Between FIGS. 26a and 26b, the user has selected node 216k by pushing down one of the mouse buttons and dragging the node 216k to right by moving the mouse. In other embodiments, a touch screen may be employed using analogous motions to select and move a node. As shown by comparing FIGS. 26a and 26b, the links between node 216k and the adjacent nodes have been maintained and are more easily viewable in FIG. 26b than in FIG. 26a. The node 216k can be pulled by the user in any two-dimensional direction to clarify the viewing of the surrounding nodes.

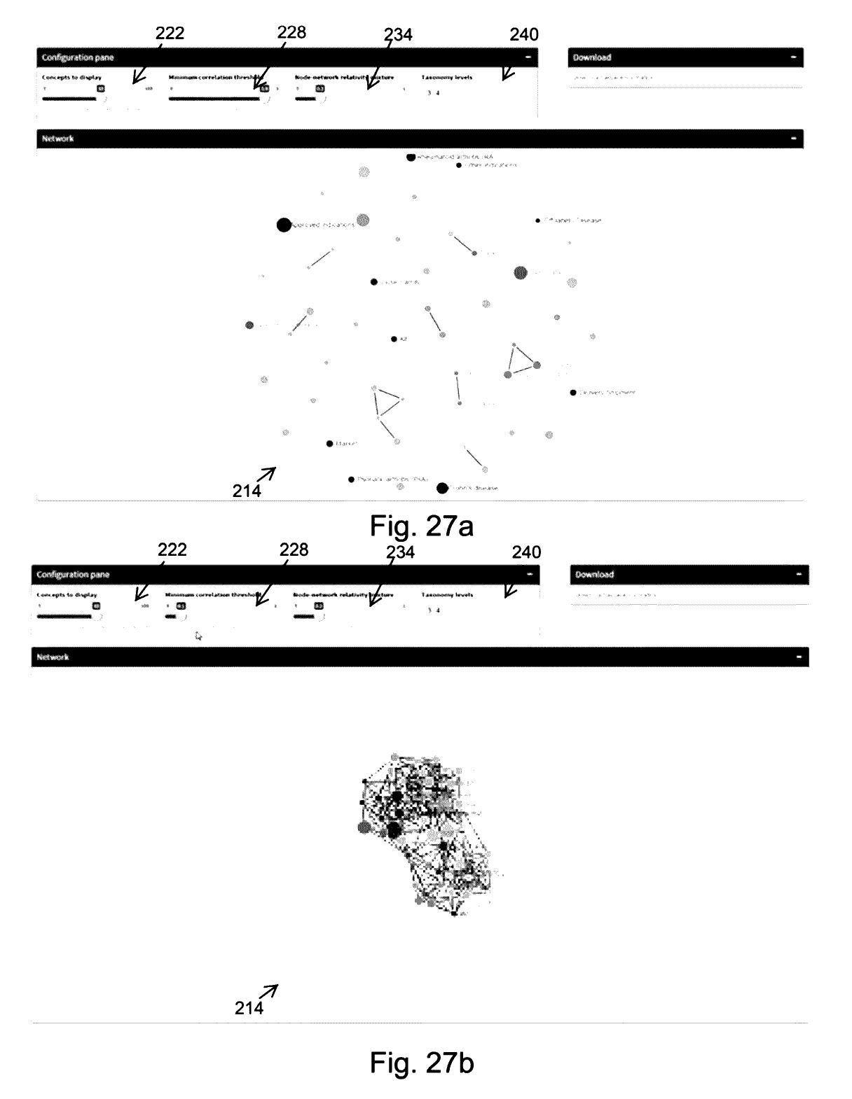

FIGS. 27a and 27b show views of the embodiment shown in FIG. 24 to illustrate how modifying the minimum correlation threshold via minimum correlation threshold delimiter 228 alters the view of the visual network displayed in visual network display section 214. In both of FIGS. 27a, 27b, the total number of nodes 216 displayed is set via node number delimiter 222 at fifty-three, the taxonomy levels are set via taxonomy display delimiter 240 at Level 3 and Level 4 and the node-network relativity mixture is set via node-network relativity mixture delimiter 234 at 0.2. In FIG. 27a, the minimum correlation threshold is set to 0.9, thus the visual network display section 214 only displays the links between the displayed fifty-three nodes that are in the top 10% (i.e., 90% to 100%) of the node-network relativity mixture value M set by node-network relativity mixture delimiter 234, as explained below with respect to FIG. 29a. There are only fourteen links 218 shown in FIG. 27a, which indicates there are fourteen links between the fifty-three nodes 216 that have a node-network relativity mixture value M in the top 10%. In FIG. 27b, the minimum correlation threshold is set to 0.1, thus the visual network display section 214 displays the links between the displayed fifty-three nodes that are in the top 90% (i.e., 10% to 100%) of the node-network relativity mixture value M set by node-network relativity mixture delimiter 234.

FIGS. 28a and 28b show views of the embodiment shown in FIG. 24 to illustrate how modifying the node-network relativity mixture parameter between the two extremes via node-network relativity mixture delimiter 234 alters the view of the visual network displayed in visual network display section 214. In FIGS. 28a, 28b, the total number of nodes 216 displayed is set via node number delimiter 222 at fifty-three, the taxonomy levels are set via taxonomy display delimiter 240 at Level 3 and Level 4 and the minimum correlation threshold is set via minimum correlation threshold delimiter 228 at 0.45.

The node-network relativity mixture parameter affects the network in the sense that the first extreme (value of 1), as shown in FIG. 28a, is an absolute measure in the sense that every correlation value is treated in the same way. In the second extreme (value of 0), as shown in FIG. 28b, a correlation value is compared relatively to the other links of a node. The main difference between the two extremes is that when the value is 0, every node will have some significant links, because even if all the links are weak, there is always a strongest link.

Node-network relativity mixture delimiter 234 is configured as a button 236 slidable along a scale 238 to select a value between 0 and 1 for the node-network relativity mixture. Sliding button 236 to the left, towards 0, increases the overall changes for each node 216 to linked to two other nodes 216, but decreases the chances that each node 216 is linked to more than two nodes 216, and sliding button 236 to the right, towards 1, decreases the overall chances for each node 216 to linked to another node 216, but increases the chances that each node 216 is linked to more than two nodes 216. Thus, as shown in FIG. 28a, with the node-network relativity mixture parameter set to 0, each node is linked to at least two other nodes, but no node includes a large number of links. As shown in FIG. 28b, with the node-network relativity mixture parameter set to 1, there are more nodes that are linked to a large number of other nodes and there are nodes that are not linked to any other nodes. Accordingly, setting the node-network relativity parameter to 1 results in clustering of the nodes representing the most frequent topics—i.e., topics that appear in a large number of documents clustered into groups with other related topics that appear a large number of documents.

As discussed in further mathematical detail below with respect to FIG. 29a, setting the node-network relativity parameter to 1 emphasizes the “network” aspect of this parameter and involves a comparison of the topic overlap relative to the entire network, while setting the node-network relativity parameter to 0 emphasis the “node” aspect of this parameter and involves a comparison of the topic only to the other topics with which the topic appears in documents.

FIG. 29a shows a flowchart for a method of determining the links between nodes in accordance with an embodiment of the present invention. A first step 242 includes filtering the top topics, i.e., the topics appearing in the most documents, as delimited via node number delimiter 222, and displaying the nodes corresponding to the top topics in visual network display section 214. A second step 244 includes computing the co-occurrence frequencies between each topic and each of the other topics. Most importantly, the co-occurrence frequencies are established for the topics represented by the nodes 216 delimited by node number delimiter 222. The co-occurrence frequency is how often two topics appear in the same document and is defined by the formula:

P_ij=d_ij/d_t (1)

where:
P_ij=the co-occurrence frequency of topic i and topic j;
d_ij=a number of documents with both topic i and topic j; and
d_t=a total number of documents of the corpus.

A third step 246 includes utilizing the co-occurrence frequencies of the topics to compute a normalized co-occurrence matrix for the topics. The normalized co-occurrence is defined by the formula:

N_ij=P_ij/(P_i*P_j) (2)

where:
N_ij=the normalized co-occurrence of topic i and topic j;
P_i=(a number of documents with topic i)/d_t; and
P_j=(a number of documents with topic j)/d_t.
   (P_i*P_j) represents the “expected” value of P_ij if the two topics were independent (in the mathematical sense) from each other. Thus, N_ij represents the “deviation from independence”, i.e. a value of 3 means that topics i and j appear 3 times more often together than would be expected by randomness. This value N_ij is also referred to in statistics as the “lift.” In other words, the normalized co-occurrence is based on the size of the overlap between two topics in comparison to the default overlap that is to be expected given the respective size of each two topics.

A fourth step 248 includes computing a node-level rank version of the normalized co-occurrence for the topics. The node-level rank version of the normalized co-occurence is defined by the following formula:

R_ij=max(rank(N_ij,N_i),rank(N_ij,N_j) (3)

where:
R_ij=the node-level rank version of the normalized co-occurence of topic i and topic j; and
N_i=the set of all N_ij for all values of j={N_ij, j in (1, . . . , number of nodes)}.
   The resulting matrix is a rank version of N_ij. In other words, the value of a given link is replaced by the rank of the given link compared to the other links of the two nodes the given link links together. There are two ranks for the given link (one for each node), so the maximum of both, i.e., whichever of the two ranks is higher, is taken. In other words, the node-level rank version is based on the size of the overlap between two topics in comparison to the other overlaps of each of these two topics with all other topics.

A fifth step 250 includes computing a mixture of the normalized co-occurrence and the node-level rank—the node-network relativity mixture—of the topics, based on a node-network relativity mixture parameter, which is variable from 0 to 1, set via node-network relativity mixture delimiter 234. The node-network relativity mixture is defined by the following formula:

M_ij=m*N_ij+(1−m)*R_ij (4)

where:
M_ij=node-network relativity mixture; and
m=the node-network relativity mixture parameter
   It should be noted that when m=1, M=N, while when m=0, M=R. Also, when m is between 0 and 1, M is between N and R (thus the name “mixture”).

A sixth step 252 includes filtering the resulting links in M based on a minimum correlation threshold via minimum correlation threshold delimiter 228. The minimum correlation threshold represents the quantile on which to be filtered, i.e. if the minimum correlation threshold is 0.8, it means keeping the links with node-network relativity mixture values M in the top 80% to 100%.

A seventh step 254 includes drawing or generating the nodes resulting from step 242 and the links resulting from step 252 on visual network display section 254 of GUI 202 using force-directed graph drawing such that the visual network of nodes 216 and links 218 displayed in section 214 is configured to automatically adjust to an aesthetically pleasing view according to a force-directed graph drawing algorithm.

The steps described with respect to FIG. 29a and GUI 202 advantageously illustrate correlations between the healthcare treatment topics of different categories. For example, links between Level 3 and Level 4 subcategories of different Level 1 categories provide insights regarding the use of pharmaceuticals, including those related to the questions or comments of HCPs and patients.

In summary, GUI 202 allows a user to modify inputs to vary the display of links between nodes representing topics by modifying a nodes input delimiting a number of the nodes to be displayed in the visual network and by modifying at least one links input delimiting the links to be displayed in the visual network. The at least one links input includes a first link input delimiting the links based on a modifiable metric representing a mixture of a first metric and a second metric. The first metric—a normalized co-occurrence—indicates a strength of potential links of each of the topics represented by one of the delimited nodes in the data set with each of the topics represented by the other delimited nodes of the data set. The second metric—a rank of the normalized co-occurrence—indicates a strength of each of the potential links of the delimited nodes in comparison to other potential links of the two respective delimited nodes each of the potential links is connecting. More specifically, node-network relativity mixture delimiter 234 allows the user to select a value between 0 and 1 for the modifiable metric—the node-network relativity mixture—to vary how the nodes are linked to each other. This technical feature provides the user with a unique tool to vary the types of relationship shown between the topics in an efficient and effective manner to generate links that are unable to be shown by either of the first and second metric alone, i.e., links that are only perceivable by manipulating the value of modifiable metric.

FIG. 29b shows an electronic system 400 configured for displaying and modifying GUI 202 in accordance with the description of FIGS. 19 to 29a. Electronic system 400 in a preferred embodiment is the server 402 or part of the server mentioned above and thus includes at least one memory and at least one processor. Electronic system 400 includes a generating module 404 configured for generating a visual network generator GUI 202 configured to display a visual network comprised of a plurality of nodes 216 and links 218, with each of the nodes 216 corresponding to a healthcare treatment topic and each of the links 218 connecting two of the nodes 216. Electronic system 400 also includes a first receiving module 406 configured for receiving a nodes input delimiting a number of the nodes 216 to be displayed in the visual network and a second receiving module 408 configured for receiving at least one links input delimiting the links 218 to be displayed in the visual network. The at least one links input including a first link input delimiting the links based on the modifiable metric, specifically the node-network relativity mixture, representing a mixture of a first metric, specifically the normalized co-occurrence, and a second metric, specifically the rank of the normalized co-occurrence. Generating module 404 is also configured for generating, in response to the nodes input and the at least one links input, the delimited nodes and the delimited links in the visual network on the visual network generator graphical user interface to illustrate correlations between the healthcare treatment topics of different categories.

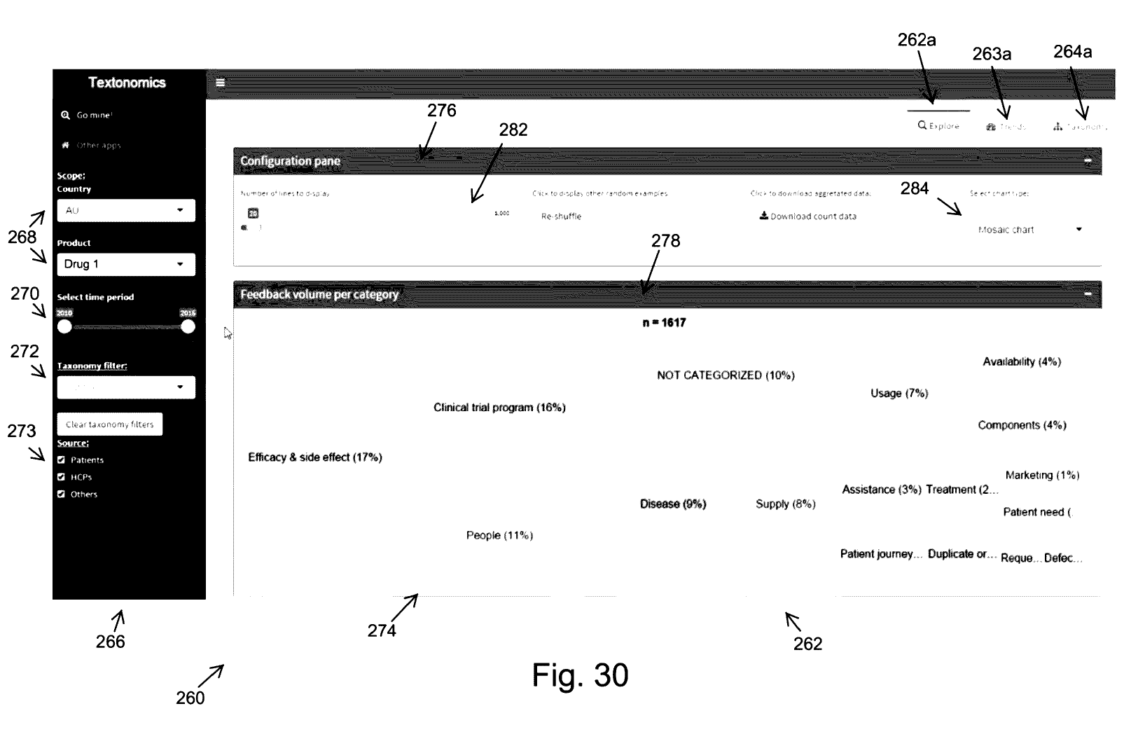

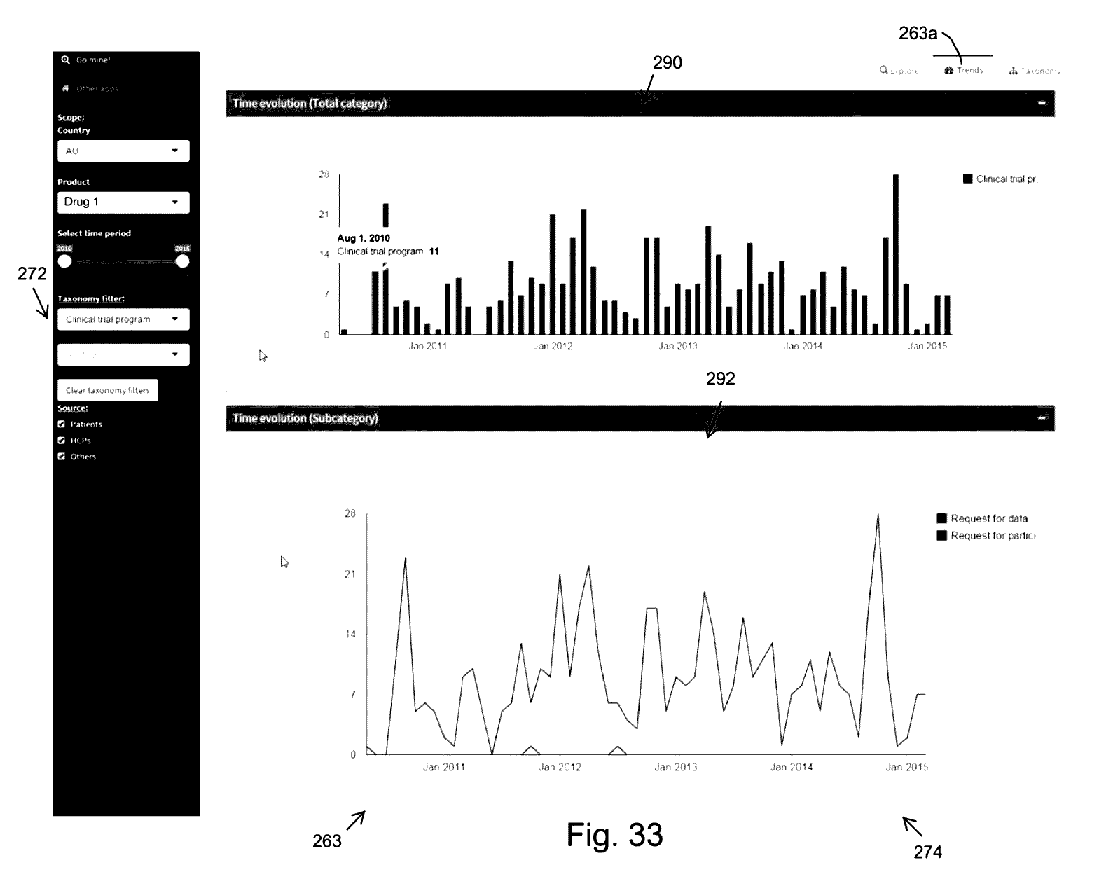

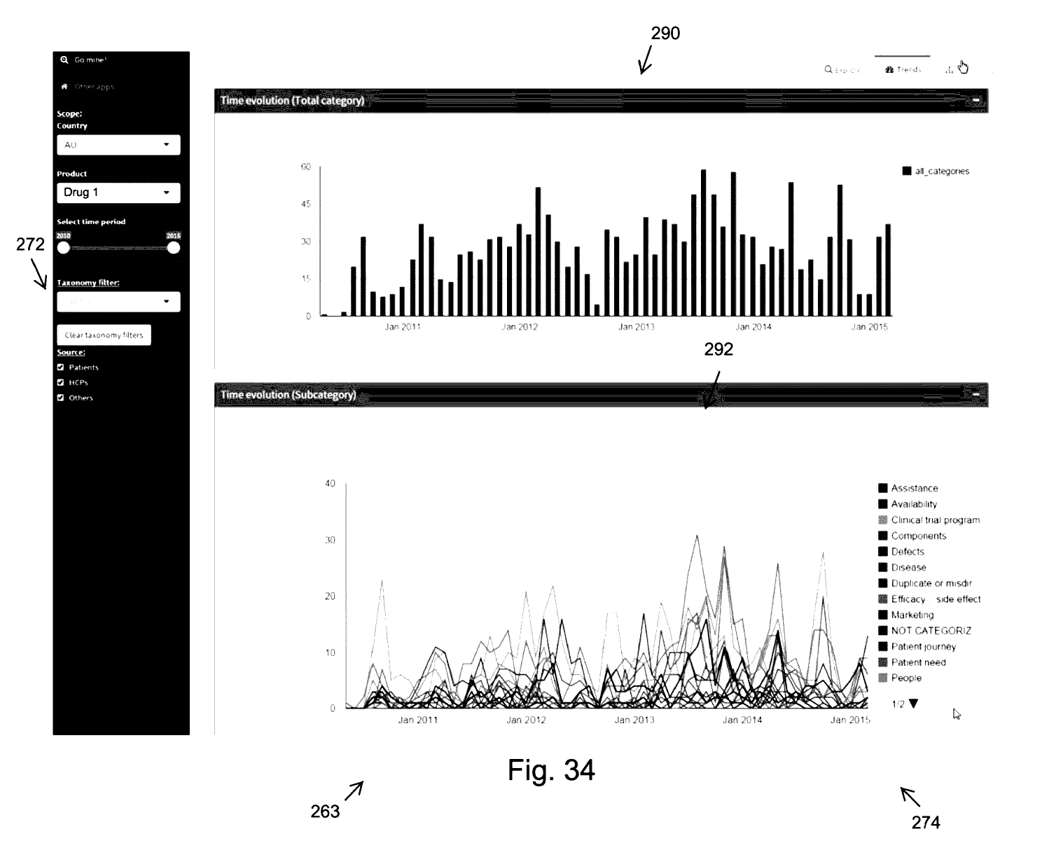

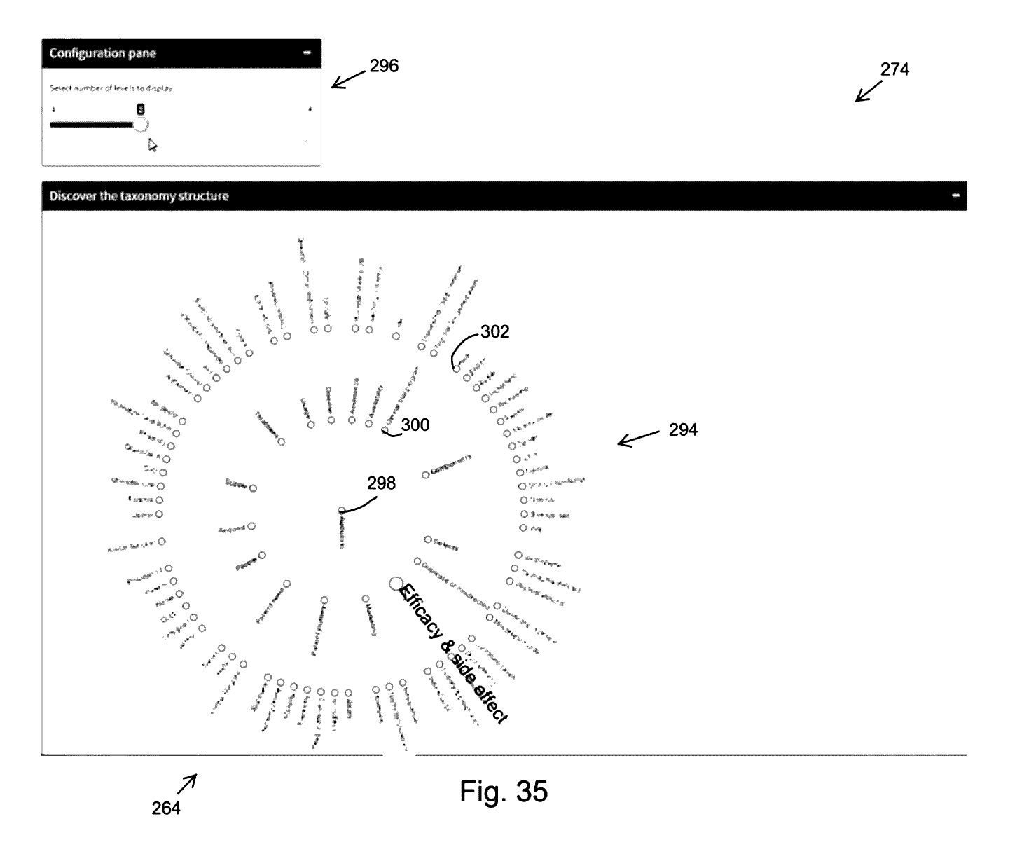

FIG. 30 illustrates a first view of a fourth application GUI 260 generated by fourth application 18 according to the exemplary embodiment of the present invention. The fourth application GUI 260—i.e., a categorized topic viewer GUI—includes three tools for exploring the categorized data, as categorized by the second application GUI 32. The three tools include a text explorer tool 262 (FIGS. 30 to 32) usable by selecting an explore icon 262a, a trend graph generating tool 263 (FIGS. 33 and 34) usable by selecting a trends icon 263a and taxonomy viewing tool 264 (FIG. 35) usable by selecting a taxonomy icon 264a. Categorized topic viewer GUI 260 includes a panel 266 at a left-side region thereof allowing a user to select a textual model defining a corpus of documents to explore and a number of terms to display. In the embodiment shown in FIG. 30, the textual model is selected from a list of options displayed in a model delimiter in the form of drop-down menus 268. The drop-down menus 268 are used to delimit a textual model defined by a healthcare treatment product of interest and a geographic region. For the example shown in FIG. 30, the selection made in drop-down menus 268 relates to Drug 1 and the geographic region of Australia. Panel 266 also includes a time period delimiter 270 for entering the start and ends dates of the data to display in GUI 260, a taxonomy filter 272 for delimiting categorized topics to display in GUI 260 and a source delimiter 273 source delimiter 315 allowing the user to select patients, HCPs and/or others as being the source of the text. In the view show in FIG. 30, no topic category of the taxonomy is select, so the data displayed in GUI 260 relates to the entire corpus of the delimited textual model.

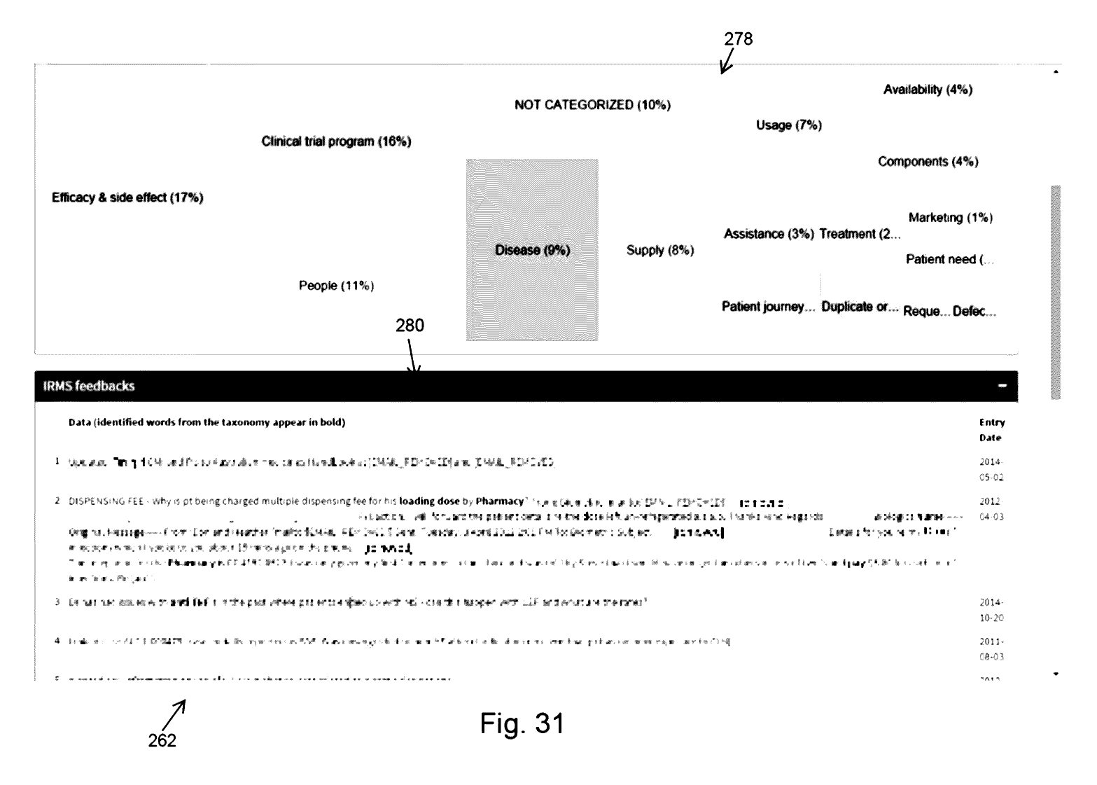

The views in FIGS. 30 to 32 show the text explorer tool 262 within a data window 274 of GUI 260. Text explorer tool 262 includes a configuration pane 276 (FIG. 30), a chart display pane 278 (FIGS. 30 to 32) and a text review pane 280 (FIGS. 31 and 30). Configuration pane 276 includes text delimiter 282 allowing the user to delimit a number of documents whose text is displayed in text review pane 280 and a chart delimiter 284 allowing a user to delimit the chart type shown in chart display pane 278. In the view of FIGS. 30 to 32, a mosaic chart is shown. The mosaic chart, related to the data set from the medical information system, provides the feedback volume per category of the taxonomy as the percentage of the data of the corpus that relates to each of the Level 1 categories and a total number n, which is shown in FIG. 30 as 1617. In this embodiment, each document may be included in more than one of the Level 1 categories. Accordingly, the total number n denotes the total number of instances a Level 1 category has been applied to the documents of the corpus. For example, as shown in chart display pane 278 of FIGS. 30 and 31, the Level 1 topic of “Efficacy & side effect” is the largest topic at 17% and “Clinical trial program” is the next largest topic at 16%. “Not Categorized” represents the number of documents that were not assigned to any category, which can be because the question is too ambiguous/not clear, or because it is about a new topic that has not yet been defined. Thus, this category is useful to maintain and extend the taxonomy.

As shown in FIG. 31, text review pane 280 lists the actual text of the documents—i.e., feedbacks, with identified patterns of the taxonomy, as specified in GUI 58 by saving with taxonomy improvement tool 58b, signified by bolding the words of the identified patterns. As the chart displayed in chart display pane 278 relates to the entire corpus, the saved patterns of all the categories of the taxonomy are signified by bolding. In other embodiments, the patterns by be signified by other signifiers, such as underlining, highlighting or italicizing. The signifying of the identified patterns allows the user to review the text of the documents and easily identify the key points.

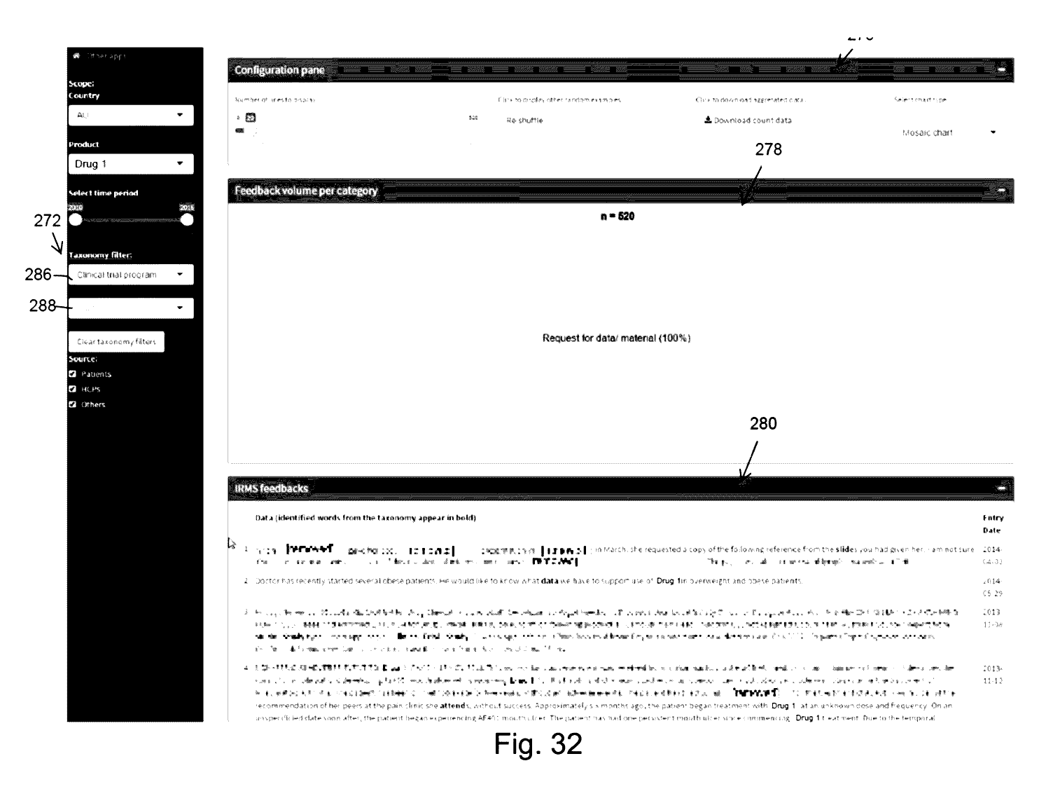

Categories of the taxonomy are selectable via taxonomy filter 272 to display actual text of only the documents in the selected category in text review pane 280. As shown in FIG. 32, the Level 1 category “Clinical trial program” was selected via taxonomy filter 272 via a first drop-down menu 286, which caused generation of a second drop-down menu 288 below first drop-down menu 288. Second drop-down menu 288 is usable to select Level 2 categories within, i.e., are subcategories of, the selected Level 1 category. The generation of a further drop-down menu for the next lower level category is prompted by the selection of each category in taxonomy filter 272. Accordingly, upon selection of the Level 2 category, a Level 3 category selection drop-down menu is generated below second drop-down menu 288. The selection of a Level 1 category via taxonomy filter 272 also causes the Level 2 categories within the Level 1 category to generate within chart display pane to illustrate the feedback volume per Level 2 category of the selected Level 1 category as the percentage of the data of the selected Level 1 category that relates to each of the Level 2 categories of the Level 1 category and a total number n, which is shown in FIG. 32 as 520. The total number n denotes the total number of instances a Level 2 category has been applied to the documents of the Level 1 category. For example, as shown in chart display pane 278 of FIG. 32, the Level 1 topic of “Clinical trial program” is substantially made up of a single Level 2 topic of “Request for data/material” defining 100% thereof (as shown below with respect to FIG. 33, this number is rounded up and a very small second Level 2 topic of “Request for participation” is also included within “Clinical trial program”). Text review pane 280 lists the actual text of the documents of the selected Level 1 category with the saved patterns categorized under the selected Level 1 category being signified by bolding.

The views in FIGS. 33 and 34 show the trend graph generating tool 263 within data window 274 of GUI 260. Trend graph generating tool 263 includes a higher level trend pane 290 and a lower level trend pane 292. Higher level trend pane 290 generates a graph, which in this embodiment is a bar graph, illustrating the number of documents related to the Level 1 category “Clinical trial program,” as selected via taxonomy filter 272, over time. Lower level trend pane 292 generates a graph, which in this embodiment is a line graph, illustrating the number of documents in the Level 2 categories within the selected Level 1 category over time. Lower level trend pane 292 shows two lines—one representing the Level 2 category of “Request for data/material” and one representing the Level 2 category of “Request for participation.” The line illustrating “Request for data/material” in higher level trend pane 290 varies in substantially the same manner as the bars for “Clinical trial program” in lower level trend pane 292, due to the Level 2 category of “Request for participation” being very uncommon.

If taxonomy filter 272 is left blank, as shown in FIG. 34, all of the categories of the selected corpus are shown together in higher level trend pane 290 and each of the Level 1 categories is shown as a separate line in lower level trend pane 292.

The view in FIG. 35 shows the taxonomy viewing tool 264 within data window 274 of GUI 260. Taxonomy viewing tool 264 includes a taxonomy structure 294 visually illustrating the relationships between the categories of the taxonomy for the selected corpus. The number of category levels that are generated in taxonomy structure 294 is dictated by level selection pane 296 of taxonomy viewing tool 264. In the view shown in FIG. 35, two levels of categories are selected and thus Level 1 and Level 2 categories are generated in taxonomy structure 294, with each topics belonging to one of levels being generated at the same radial distance from the center of the structure 294. Taxonomy structure 294 includes a center node 298 defining the taxonomy as a whole and a plurality of first level nodes 300 representing the Level 1 categories that are each connected to center node 298 by a respective line and to branch the Level 1 categories outwardly from center node. The first level nodes 300 are all the same first radial distance from center node 298. Radially outside of the first level nodes 300, a plurality of second level nodes 302 representing the Level 2 categories, which are subcategories of the Level 1 categories, that are each connected to the one corresponding Level 1 category the Level 2 category is included within by lines that branch outwardly from the corresponding first level node 300 to the corresponding second level nodes 302. The second level nodes 302 are all the same second radial distance from center node 298, with the second radial distance being greater than the first radial distance. Level section pane 296 may be used to add Level 3, which are subcategories of the Level 2 categories, and Level 4 categories, which are subcategories of the Level 3 categories, to taxonomy structure 294 to generate third level nodes outside of second level nodes 302 connected to the corresponding second level nodes 302 by lines and to generate third level outside of the third level nodes connected to the corresponding third level nodes by lines. As noted above, the third level nodes are generated to be at the same third radial distance from center node 298 and fourth level nodes are generated to be at the same fourth radial distance from center node 298, with the third radial distance being greater than the second radial distance and the fourth radial distance being greater than the third radial distance. For the view of taxonomy viewing tool 264 shown in FIG. 35, taxonomy filter 272 (FIGS. 30, 32 to 34) is left blank such that all of the topics for the selected category level are shown in taxonomy structure 294. However, specific categories may be selected for display via taxonomy filter 272 in the same manner as described above with respect to tools 262, 263. The name of a topic may be enlarged by for example moving the mouse cursor over the node associated with the topic as shown in FIG. 35 with “Efficacy & side effect.”

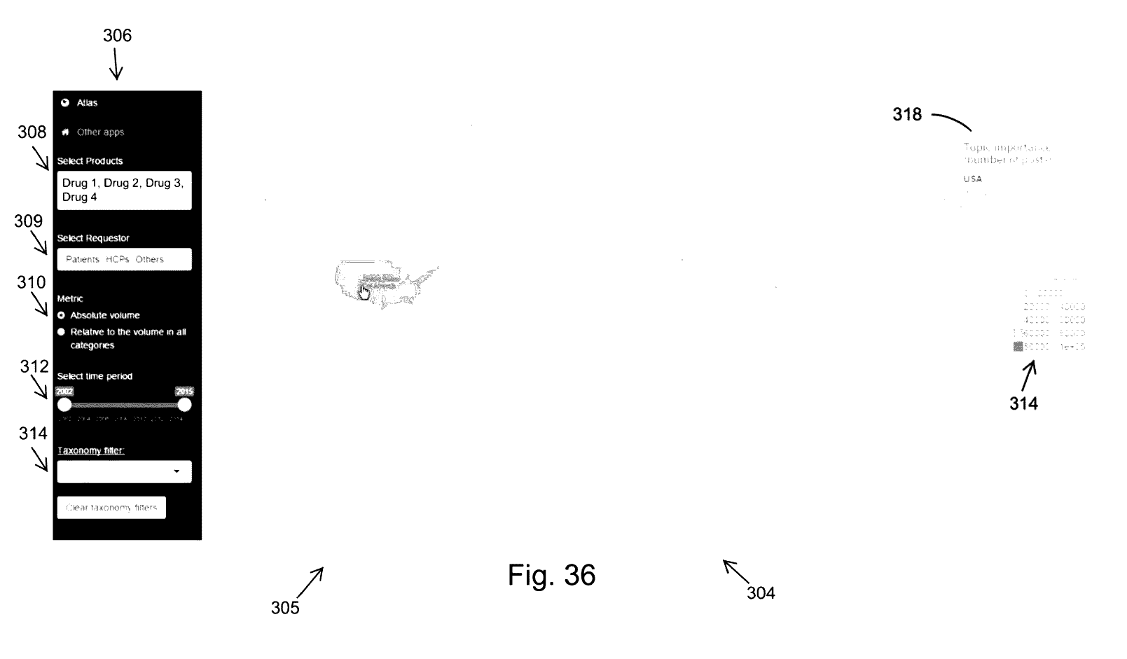

FIG. 36 illustrates a first view of a fifth application GUI 304 generated by fifth application 20 according to an embodiment of the present invention. The fifth application GUI 304—i.e., a topic mapping GUI—includes a map display section 305 displaying an interactive global map of the Earth and a panel 306 at a left-side region thereof allowing the user to select a textual model defining a corpus of documents to explore. Panel 306 includes a product delimiter 308 allowing a user to enter one or more healthcare treatment products to define the corpus. In the view shown in FIG. 36, the products Drug 1, Drug 2, Drug 3 and Drug 4 are selected in product delimiter 308.

Panel 306 also includes a source delimiter 309 allowing the user to select patients, HCPs and/or others as being the source of the text and a metric delimiter 310 allowing the user to a select a first metric that generates data within map display section 305 by absolute volume or a second metric that generates data with map display section 305 relative to the volume in all categories. Panel 306 further includes a time period delimiter 312 for entering the start and ends dates of the data to display in map display section 305 and a taxonomy filter 314 for delimiting categorized topics to display in map display section 305.

As shown in FIG. 36, countries where data from the medical information system for the selected products is available are represented in accordance with a map key 316 illustrated in map display section 305. In the view shown in FIG. 36, because taxonomy filter 314 is left blank, the number of entries or posts (i.e., documents) for the entire selected corpus is illustrated for each corresponding country in map display section. For example, according to the coloring of the countries and the map key 316, during the selected time period, there are more than 80,000 posts in the U.S. and between 0 and 20,000 posts in Canada, France, Germany, England and Australia. As shown in FIG. 36, upon moving the mouse cursor over a country, here the U.S., a display window 318 is generated to display the exact number of posts—95,872.

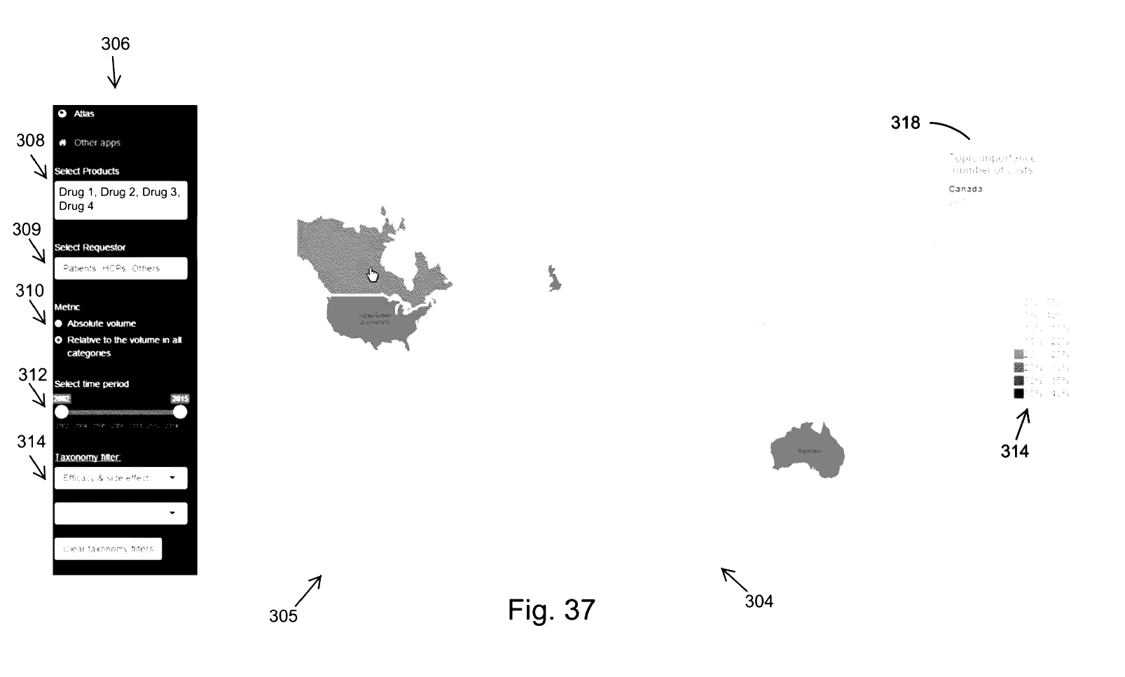

Categories of the taxonomy are selectable via taxonomy filter 314 to display the number of documents only within the selected category in map display section 305. As shown in FIG. 37, the Level 1 category “Efficacy & side effect” was selected via taxonomy filter 314 via a first drop-down menu 320, which caused generation of a second drop-down menu 322 below first drop-down menu 320, in the same manner as described above with respect to taxonomy filter 272. Accordingly, second drop-down menu 322 is usable to select Level 2 categories within the selected Level 1 category. Additionally, instead of the first metric of “Absolute volume” being selected as with respect to FIG. 36, the second metric of “Relative to the volume in all categories” is selected in FIG. 37 such that the map and the map key 316 are modified to generate the number of posts the selected Level 1 category “Efficacy & side effect” has been applied to the documents of the corpus as a percentage of the total number of times all of the Level 1 categories have been applied to document in each respective country. For example, according to the coloring of the countries and the map key 316, between 30% and 35% of the categorized documents in the U.S., England and Australia relate to the Level 1 category “Efficacy & side effect”, between 25% and 30% of the categorized documents in the Canada relate to the Level 1 category “Efficacy & side effect”, between 15% and 20% of the categorized documents in the Germany relate to the Level 1 category “Efficacy & side effect” and between 10% and 15% of the categorized documents in the France relate to the Level 1 category “Efficacy & side effect”. As shown in FIG. 37, upon moving the mouse cursor over a country, here Canada, display window 318 is generated to display the exact percentage of posts—26.5%. This feature of GUI 304 allows a user to determine the relative importance of the topic in different countries.

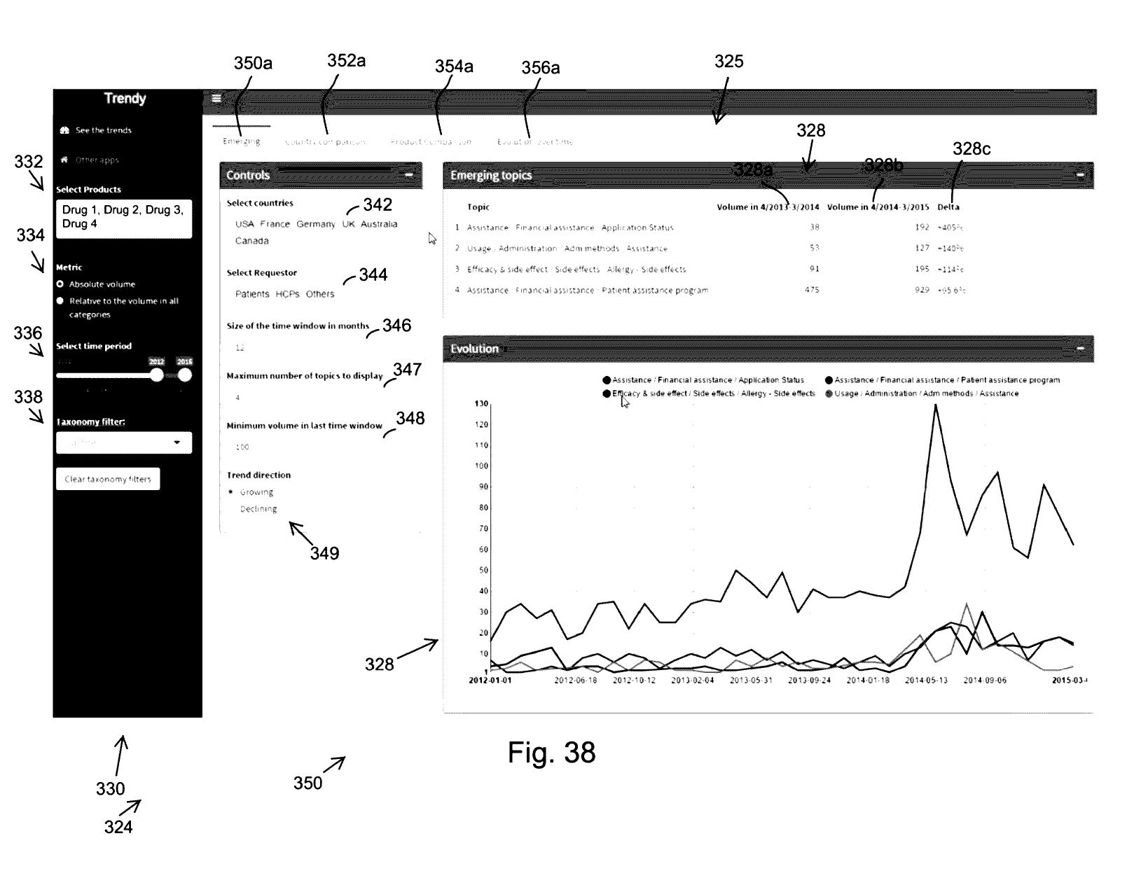

FIG. 38 illustrates a first view of a sixth application GUI 324 generated by sixth application 22 according to an embodiment of the present invention. The sixth application GUI 324—i.e., a trend generating GUI—includes four tools that can be generated within a trend analysis pane 325 of GUI 324. The tools include an emergence tool 350 selectable via an emergence icon 350a, a country comparison tool 352 selectable via a country comparison icon 352a, a product comparison tool 354 selectable via a product comparison icon 354a and an evolution tool 356 selectable via an evolution icon 356a. Similar to the above described GUIs, GUI 324 also includes a panel 330 at a left-side region thereof allowing the user to select a textual model defining a corpus of documents to explore. Panel 330 includes a product delimiter 332 allowing a user to enter one or more healthcare treatment products to define the corpus for display within trend analysis pane 325, a metric delimiter 334 allowing the user to a select a first metric that generates data within trend analysis pane 325 by absolute volume or a second metric that generates data within trend analysis pane 325 relative to the volume in all categories, a time period delimiter 336 for entering the start and ends dates of the data to display in trend analysis pane 325 and a taxonomy filter 338 for delimiting categorized topics to display in trend analysis pane 325.

FIG. 38 illustrate the emergence tool 350, which includes an emerging trend graphing section 326 displaying the most prevalent changes in the data over time and an emerging topics table 328 listing the topics that increased by the largest percentages over the past year. Emergence tool 350 also includes a control panel 340 including a plurality of additional controls for emerging trend graphing section 326, including a geographic delimiter 342 for delimiting the countries whose data is included in the data set, a source delimiter 344 for delimiting the source of the data—HCPs, patients and/or others, a time size delimiter 346 for delimiting the number of months to be compared in emerging topics table 328, a topic number delimiter 347 for delimiting the maximum number of topics to display in emerging topics table 328 and emerging trend graphing section 326, a minimum volume delimiter 348 for delimiting the smallest volume of documents the second time period 328b must have be displayed in emerging topics table 328 and emerging trend graphing section 326 and a trend direction delimiter 349 for delimiting whether the trend to displayed is growing or declining.

As shown in FIG. 38, emerging topics table 328 has automatically generated the four top increasing topics by percentage 328c by comparing the first period 328a—here the year ranging from April 2013 to March 2014—and a second period 328b contiguous with and more recent than the first period—here the year ranging from April 2014 to March 2015. The first period 328a and the second period 328b are generated as absolute volumes in FIG. 38 due to the selection of the “Absolute volume” metric via metric delimiter 334. For example, the top topic defined by the Level 1 category “Assistance,” the Level 2 category “Financial assistance” and the Level 3 category “Application Status” increased from appearing in 38 documents during the first period to appearing in 192 documents in the second period—a 405% increase. The insight may cause the user to formulate a hypothesis related to the provision of information regarding financial assistance or to interaction with insurance companies and/or government agencies.

The topics displayed in emerging topics table 328 are generated in emerging trend graphing section 326 and displayed over time for the time period delimited by time period delimiter 336. In FIG. 38, the four top topics of emerging topics table 328 are shown in emerging trend graphing section 326 from January 2010 to March 2015 by respective lines indicating the monthly totals of the feedbacks related to the respective topic. As shown in emerging trend graphing section 326 in FIG. 38, the line for the topic “Assistance/Financial assistance/Patience assistance program” has been more popular than the other three topics in the time period graphed. Additionally, there is large spike in the volume of documents related to the topic “Assistance/Financial assistance/Patience assistance program” around the time of May-June 2015. A user may review this data and determine that this time period should be further evaluated for this topic.

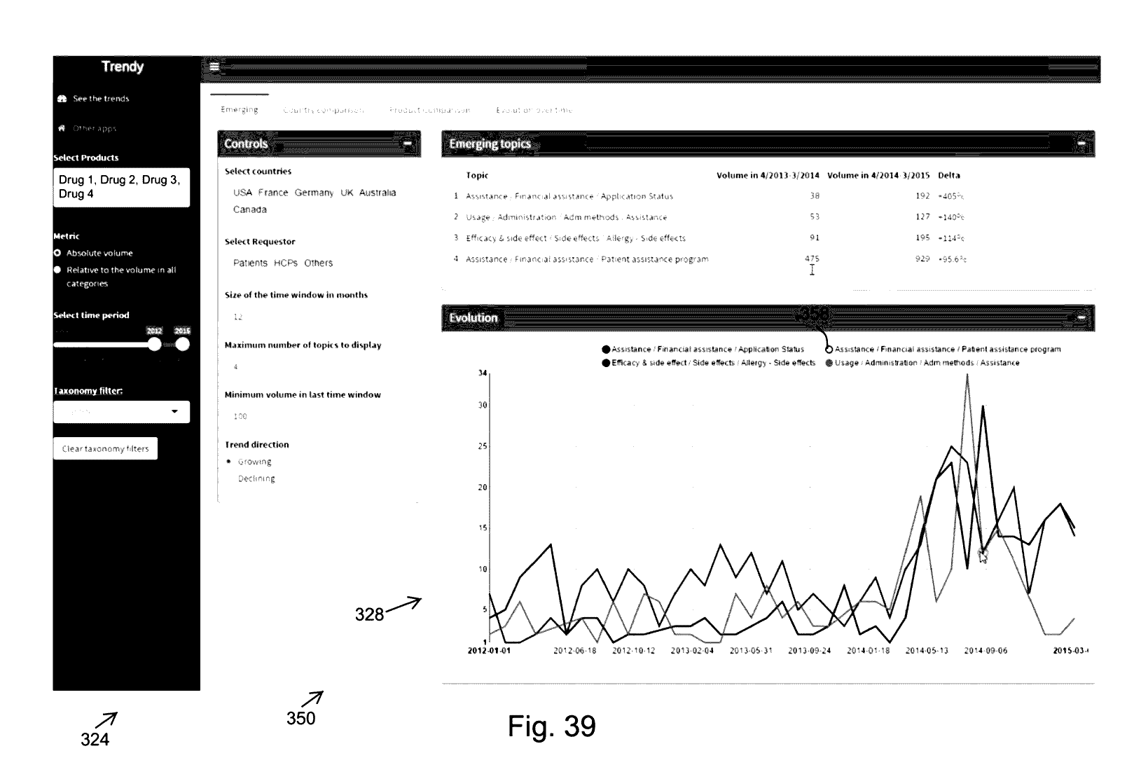

FIG. 39 shows a view of emergence tool 350 in which, in comparison with FIG. 38, emerging trend graphing section 326 has been modified to remove the line representing the topic “Assistance/Financial assistance/Patience assistance program” from emerging trend graphing section 326 by the user selecting the key icon 358 associated with the topic “Assistance/Financial assistance/Patience assistance program.” In response to the selection of key icon 358 and the removal of the line, the ordinate scale of the trend graph has been resized to conform to lines of the three remaining topics. Because the removed line corresponded to the greatest volume of documents, the ordinate scale has been decreased such that the three remaining lines are now enlarged. The enlargement advantageously allows the user to more easily review the data of the three remaining lines as compared with the view shown in FIG. 38.

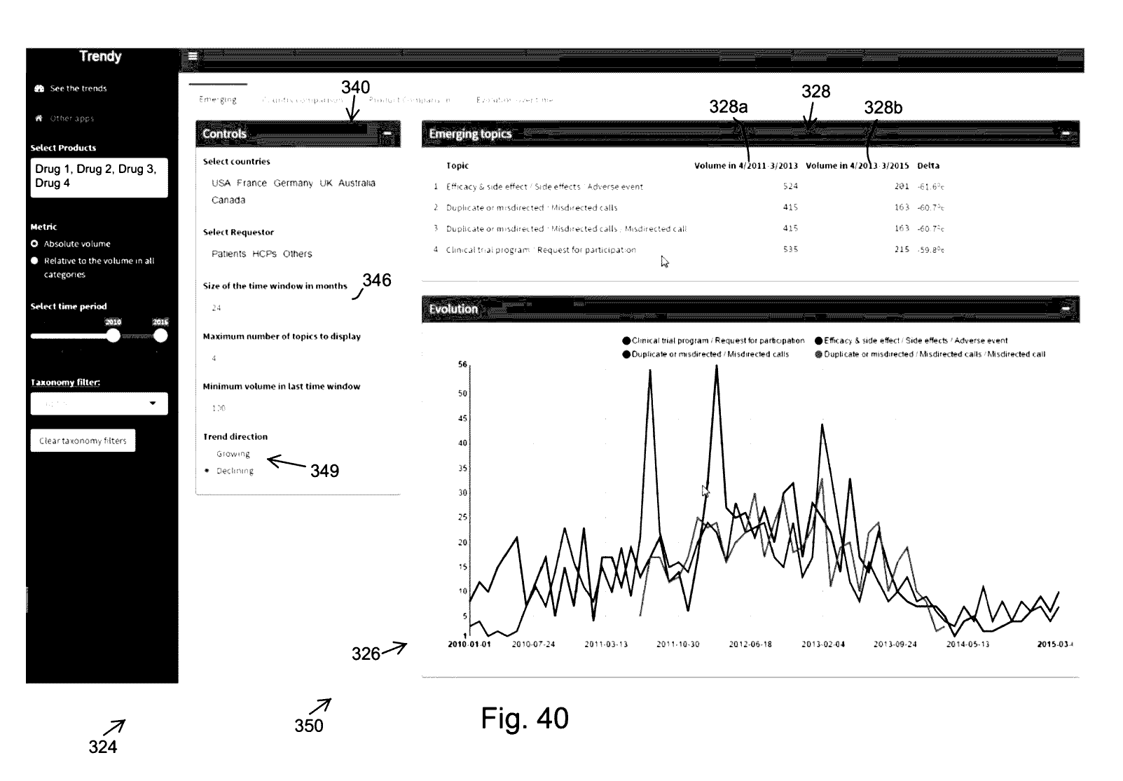

FIG. 40 shows a view of emergence tool 350 in which, in comparison with FIGS. 38 and 39, control panel 340 has been modified by the user via time size delimiter 346 to change the number of months to be compared in emerging topics table 328 from twelve to twenty-four and via trend direction delimiter 349 to change the trend to displayed from growing to declining. As shown in the emerging topics table 328 and emerging trend graphing section 326, upon these changes via control panel 340 emerging topics table 328 has been automatically updated to generate the four top decreasing topics by compare a twenty-four month first period 328a—here the year ranging from April 2011 to March 2013—and a twenty-four month second period 328b contiguous with and more recent than the first period—here the year ranging from April 2013 to March 2015. For example, the top topic defined by the Level 1 category “Efficacy & side effect,” the Level 2 category “Side effects” and the Level 3 category “Adverse events” decreased from appearing in 524 documents during the first period to appearing in 201 documents in the second period—a 61.6% decrease. The user is thus informed that adverse events for delimited products Drug 1, Drug 2, Drug 3 and Drug 4 may have decreased from the first period to the second period. The user can share this observation together with relevant stakeholders for further investigations.

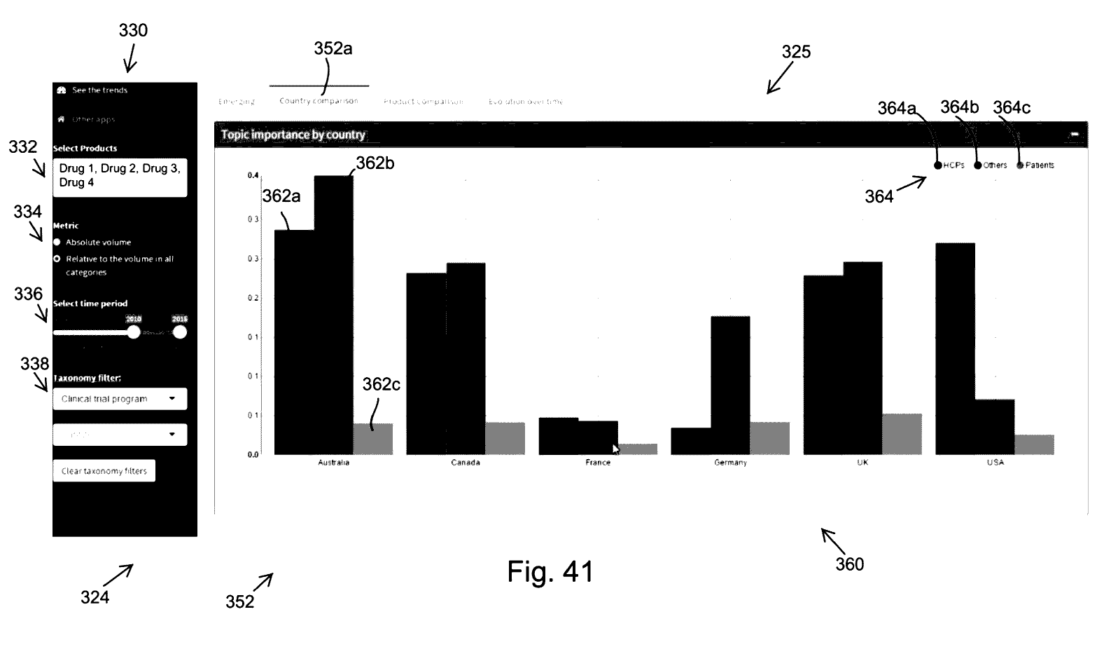

FIG. 41 illustrates the country comparison tool 352, which was generated upon selection of country comparison icon 352a, in trend analysis pane 325 of GUI 324. Country comparison tool 352 includes a country trend graphing section 360 including, in this embodiment, a bar graph displaying a comparison between the document categorizations for different countries of the entire data set from the medical information system. In the view shown in FIG. 41, products Drug 1, Drug 2, Drug 3 and Drug 4 are selected via product delimiter 332, the “Relative to the volume in all categories” is selected via metric delimiter 334, 2010 to 2015 is selected via time period delimiter 336 and the Level 1 category “Clinical trial program” is selected via taxonomy filter. Accordingly, the graph generated in country trend graphing section 360 provides a country comparison for all of products Drug 1, Drug 2, Drug 3 and Drug 4 in the form of a relative volume analysis for the documents that are related to clinical trial programs between 2010 and 2015. The bar graph displays three separate bars for each country to identify the sources of the documents. A first bar 362a represents documents from HCPs, a second bar 362b represents documents from others and a third bar 362c represents documents from patients, as corresponding to the respective icons 364a, 364b, 364c shown in source key 364.

In FIG. 41, country trend graphing section 360 indicates that, with respect to the selected products, HCPs and patients rarely generate communication regarding clinical trial programs in France and Germany, and that in Australia, Canada, UK and USA, HCPs generate communication regarding clinical trial programs much more than patients. The comparisons in FIG. 41 may cause the user to formulate a hypothesis related to availability and accessibility of clinical trials information for the selected healthcare treatment products in specific countries for patients and for HCPs, which may trigger specific actions.

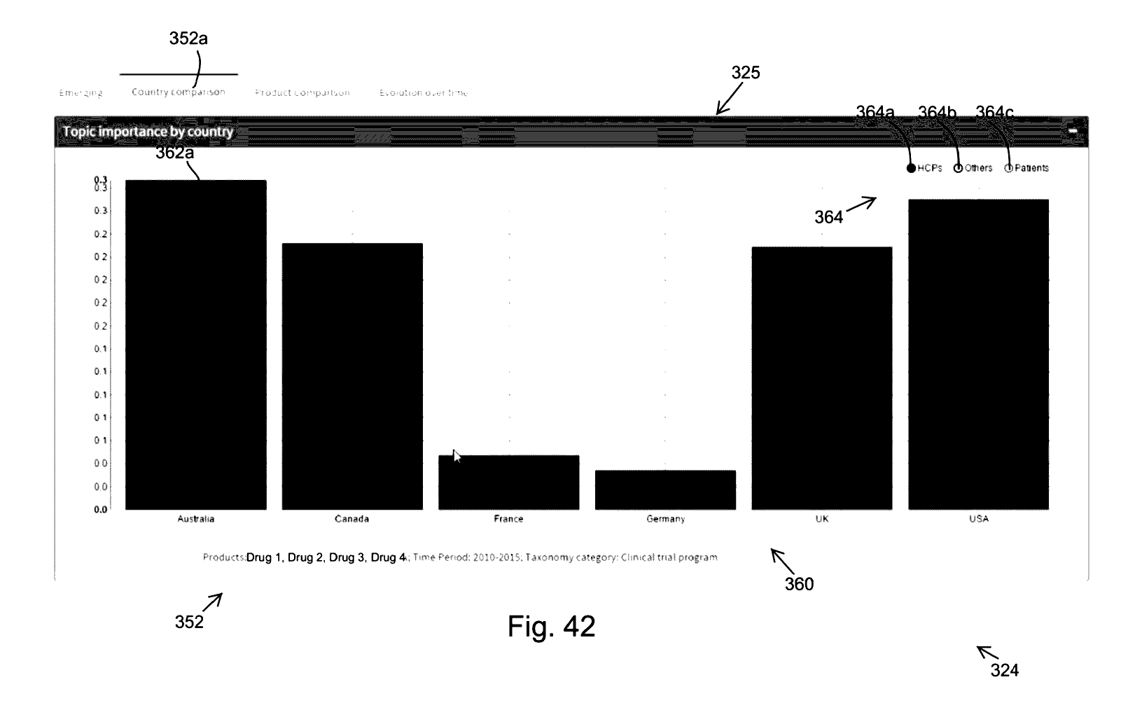

FIG. 42 shows a view of country comparison tool 352 in which, in comparison with FIG. 41, country trend graphing section 360 has been modified to remove the bars representing the sources “others” and “patients” from country trend graphing section 360 by the user selecting the key icons 364b, 364c. In response to the selection of key icons 364b, 364c and the removal of the bars, the ordinate scale of the trend graph has been resized to conform to lines of the three remaining topics. Because the removed bar 362b for “others” in Australia corresponded to the greatest relative volume of documents in FIG. 41, the ordinate scale has been decreased such that the bars 362a for HCPs are now enlarged.

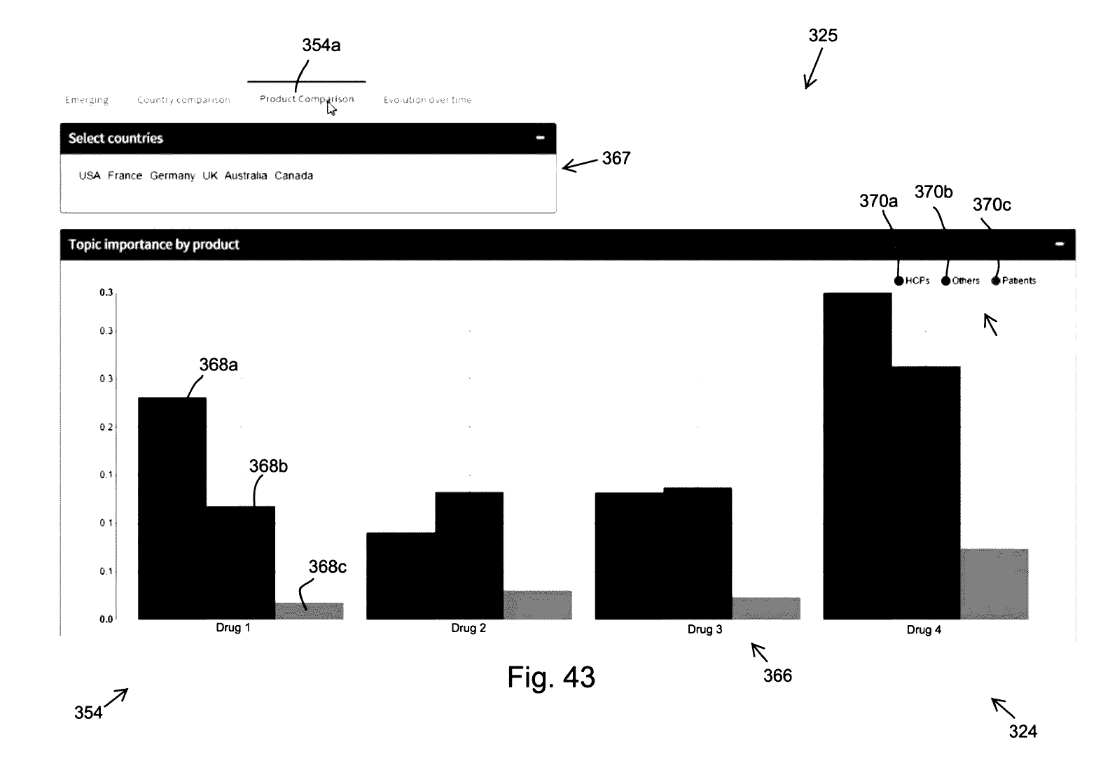

FIG. 43 illustrates the product comparison tool 354, which was generated upon selection of product comparison icon 354a, in trend analysis pane 325 of GUI 324. Product comparison tool 354 includes a product trend graphing section 366 including, in this embodiment, a bar graph displaying a comparison between the document categorizations for different products as delimited by product delimiter 332 (FIG. 38). Product comparison tool 354 also includes a country selection delimiter 367 for selecting countries for contributing to the data shown in product trend graphing section 366. In the view shown in FIG. 43, products Drug 1, Drug 2, Drug 3 and Drug 4 are selected via product delimiter 332, the “Relative to the volume in all categories” is selected via metric delimiter 334 (FIG. 38), 2010 to 2015 is selected via time period delimiter 336 (FIG. 38) and the Level 1 category “Clinical trial program” is selected via taxonomy filter 338 (FIG. 38). Accordingly, the graph generated in product trend graphing section 366 provides a comparison of products Drug 1, Drug 2, Drug 3 and Drug 4 in the form of a relative volume analysis for the documents that are related to clinical trial programs between 2010 and 2015. The bar graph, as with country trend graphing section 360, displays three separate bars for each product to identify the sources of the documents. A first bar 368a represents documents from HCPs, a second bar 368b represents documents from others and a third bar 368c represents documents from patients, as corresponding to the respective icons 370a, 370b, 370c shown in source key 370, which are selectable in the same manner as the icons 364a, 364b, 364c of source key 364 (FIG. 41) to add and remove bars from the graph. In FIG. 43, product trend graphing section 366 indicates that, with respect to the selected products, HCPs, others and patients communicate the most often respect to Drug 2 regarding clinical trial programs than the other products.

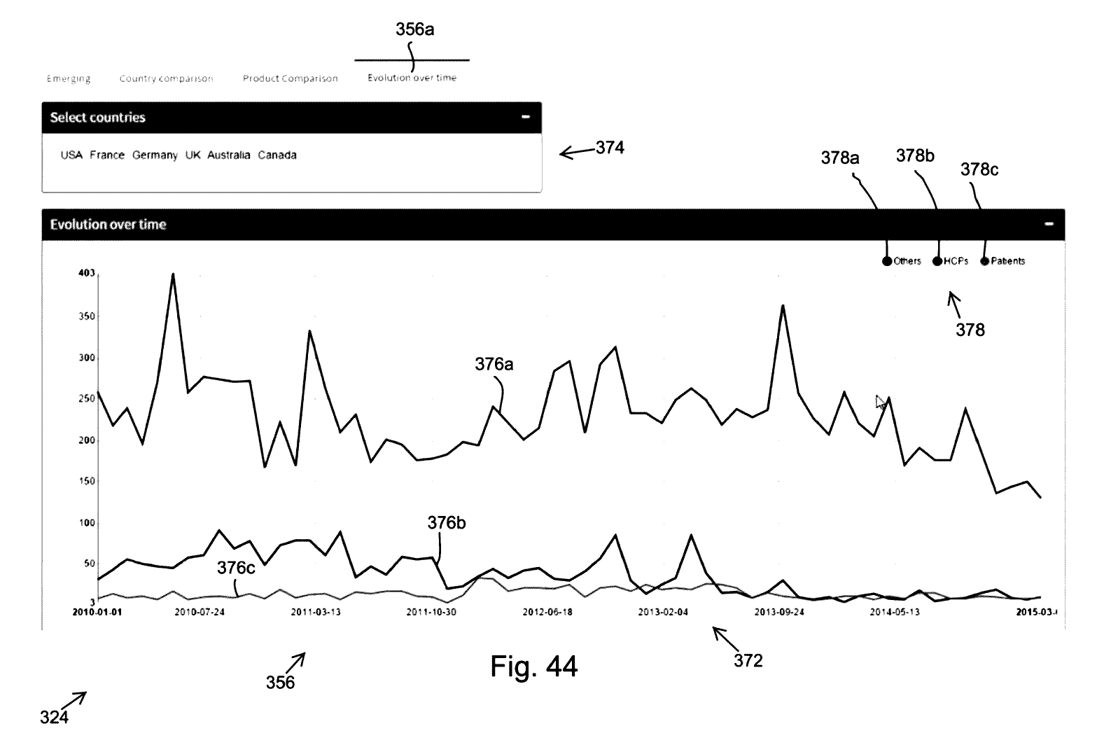

FIG. 44 illustrates the evolution tool 356, which was generated upon selection of product comparison icon 356a in trend analysis pane 325 of GUI 324. Evolution tool 356 includes an evolution trend graphing section 372 including, in this embodiment, a line graph displaying a volume of documents of a selected topic over time for each of the three sources—HCPs, others and patients—for the products as delimited by product delimiter 332 (FIG. 38). Evolution tool 356 also includes a country selection delimiter 374 for selecting countries for contributing to the data shown in product trend graphing section 372. In the view shown in FIG. 44, products Drug 1, Drug 2, Drug 3 and Drug 4 are selected via product delimiter 332, the “Absolute volume” is selected via metric delimiter 334 (FIG. 38), 2010 to 2015 is selected via time period delimiter 336 (FIG. 38) and the Level 1 category “Clinical trial program” is selected via taxonomy filter 338 (FIG. 38). Accordingly, the graph generated in evolution trend graphing section 372 provides cumulative data related to all of products Drug 1, Drug 2, Drug 3 and Drug 4 in the form of an absolute volume analysis for the documents that are related to clinical trial programs between 2010 and 2015. The line graph displays three separate lines to identify the sources of the documents. A first line 376a represents documents from HCPs, a second line 376b represents documents from others and a third line 376c represents documents from patients, as corresponding to the respective icons 378a, 378b, 378c shown in source key 378, which are selectable in the same manner as the icons 364a, 364b, 364c of source key 364 (FIG. 41) to add and remove bars from the graph. In FIG. 44, evolution trend graphing section 372 indicates that, with respect to the selected products, the source group of HCPs communicate the most often regarding clinical trial programs than the source groups of others and patients.

The above described GUIs and methods may advantageously allow a non-technical subject matter expert, i.e., someone who is knowledgeable in the healthcare treatment field, particularly in pharmaceutical development and/or pharmaceutical manufacturing and supply, but does not have technical experience in building databases and data modeling programs, to interacts with text analytics to better understand what is happening inside the data. For example, the embodiments of the invention allow a non-technical subject matter expert to understand what trends are developing and how to quantify different topics. The above described GUIs and methods may advantageously combine data modeling and taxonomy building to allow users to review and operate the organization of data related to a pharmaceutical or other healthcare treatment product and develop insights regarding the pharmaceutical or other healthcare treatment product described throughout the data set, and generate solutions accordingly. Multiple types of insights may be generated, e.g., the insights may be related to availability and accessibility of information for specific populations and specific countries; the insights may be related to identifying perceived needs and lifestyle matters in relation to treatment adherence; the insights may be related to how the product or other healthcare treatment product is used to better understand real world usage of the product or other healthcare treatment product.

The organization of the data may allow the user to quantify potential concerns, as well as testing and identify areas of improvement for a healthcare treatment product. For example, review of the data and categorizations related to a healthcare treatment product may indicate that investigating modified formulation may be possibly beneficial for a percentage of patients.

Additionally, alternative usages may be discovered, which may allow a pharmaceutical manufacturer to identify potential areas of future development.

By providing organized and clear information regarding trends, the non-technical subject matter expert may identify insights regarding potential areas of improvement, generate corresponding solutions and measure the impact of the solutions. The above described GUIs thus allow a non-technical subject matter expert to begin with raw uncategorized data, organize the data into easily reviewable categories, generate actionable insights from the organized data, develop targeted solutions based on the actionable insights, then further review future organized data to measure the impact of the targeted solutions.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A computerized method for displaying categorized healthcare textual data after a taxonomy has been applied to a data set comprising:
generating, by a server including a processor and a memory, a visual network generator graphical user interface configured to display a visual network comprised of a plurality of nodes and links, each of the nodes corresponding to a healthcare treatment topic, each of the links connecting two of the nodes;
receiving a nodes input delimiting a number of the nodes to be displayed in the visual network;
receiving, by the server, at least one links input delimiting the links to be displayed in the visual network, the at least one links input including a first link input delimiting the links based on a modifiable metric representing a mixture of a first metric and a second metric, the first metric indicating a strength of potential links of each of the topics represented by one of the delimited nodes in the data set with each of the topics represented by the other delimited nodes of the data set, the second metric indicating a strength of each of the potential links of the delimited nodes in comparison to other potential links of the two respective delimited nodes each of the potential links is connecting; and
generating, by the server, in response to the nodes input and the at least one links input, the delimited nodes and the delimited links in the visual network on the visual network generator graphical user interface to illustrate correlations between the healthcare treatment topics of different categories.

2. The computerized method as recited in claim 1 wherein the at least one links input further includes a second link input delimiting a modifiable minimum correlation threshold defining a quantile of the mixture for delimiting the links generated in the visual networks.

3. The computerized method as recited in claim 1 further comprising receiving a textual model input delimiting a corpus of documents to explore via the visual network, the textual model input delimiting a healthcare treatment product in a geographic region.

4. The computerized method as recited in claim 1 further comprising computing the first metric, the first metric being a normalized co-occurrence of links of each of the delimited nodes with respect to each of the other delimited nodes.

5. The computerized method as recited in claim 4 wherein the computing the first metric includes:
computing co-occurrence frequencies between each delimited node and the other delimited nodes, the co-occurrence frequency representing how often two topics appear in the same document; and
computing a normalized co-occurrence frequencies between the delimited node and the other delimited nodes, the normalized co-occurrence frequencies representing deviations of the co-occurrence frequencies from co-occurrence frequencies expected by randomness.

6. The computerized method as recited in claim 4 further comprising computing the second metric, the second metric being a rank of the normalized co-occurrence of links of each of the delimited nodes with respect to each of the other delimited nodes compared to the other links of the two nodes the given link connects together.

7. The computerized method as recited in claim 6 further comprising computing the mixture as mixture of the normalized co-occurrence and the node-level rank based on a node-network relativity mixture parameter.

8. The computerized method as recited in claim 7 wherein the mixture is a node-network relativity mixture defined by the following formula:
M_ij=m*N_ij+(1−m)*R_ij
where:
M_ij=node-network relativity mixture;
m=the node-network relativity mixture parameter, which range from 0 to 1;
N_ij=the normalized co-occurrence of topic i and topic j; and
R_ij=the node-level rank of topic i and topic j.

9. The computerized method as recited in claim 1 wherein the generating the delimited nodes and the delimited links in the visual network includes generating each of the nodes to have a size corresponding to a number of the documents in which the topic represented by the node is included.

10. The computerized method as recited in claim 1 wherein the generating the delimited nodes and the delimited links in the visual network includes generating each of the nodes to have a color corresponding to a highest level category in which the topic represented by the node is included.

11. The computerized method as recited in claim 1 further comprising providing a taxonomy display delimiter for receiving an input of a user delimiting at least one category level, the generating the delimited nodes and the delimited links in the visual network including generating only the nodes included in the delimited at least one category level.

12. The computerized method as recited in claim 11 wherein the delimited at least one category level includes a plurality of category levels, the generating the delimited nodes and the delimited links in the visual network includes generating delimited links connecting delimited nodes of different category levels of the delimited category levels.

13. The computerized method as recited in claim 1 further comprising moving one of the generated nodes in response to a dragging input of the user.

14. The computerized method as recited in claim 1 further comprising receiving an input of a search pattern in a taxonomy modifier graphical user interface;
displaying, by the server, in response to the input search pattern, text of the data set corresponding to the input search pattern in the taxonomy modifier graphical user interface; and
adding, by the server, in response to a user request via the taxonomy modifier graphical user interface, the input search pattern to one or more existing levels of a taxonomy of the data set to alter the structure of the taxonomy and provide a modified healthcare treatment taxonomy, the visual network generator graphical user interface being modified in response to the modified healthcare treatment taxonomy.

15. A non-transitory computer program product configured for implementing the method as recited in claim 1.

16. An electronic system including a processor and a memory for displaying categorized healthcare textual data after a taxonomy has been applied to a data set, the electronic system comprising:
a generating module configured for generating a visual network generator graphical user interface configured to display a visual network comprised of a plurality of nodes and links, each of the nodes corresponding to a healthcare treatment topic, each of the links connecting two of the nodes;
a first receiving module configured for receiving a nodes input delimiting a number of the nodes to be displayed in the visual network; and
a second receiving module configured for receiving at least one links input delimiting the links to be displayed in the visual network, the at least one links input including a first link input delimiting the links based on a modifiable metric representing a mixture of a first metric and a second metric, the first metric indicating a strength of potential links of each of the topics represented by one of the delimited nodes in the data set with each of the topics represented by the other delimited nodes of the data set, the second metric indicating a strength of each of the potential links of the delimited nodes in comparison to other potential links of the two respective delimited nodes each of the potential links is connecting,
the generating module configured for generating, by the server, in response to the nodes input and the at least one links input, the delimited nodes and the delimited links in the visual network on the visual network generator graphical user interface to illustrate correlations between the healthcare treatment topics of different categories.
